(19) United States
(12) Patent Application Publication
(10) Pub. No.: US 2019/0281052 A1
(43) Pub. Date: Sep. 12, 2019

(54) SYSTEMS AND METHODS FOR SECURING AN AUTOMOTIVE CONTROLLER NETWORK

(71) Applicant: Auton, Inc., Snoqualmie, WA (US)

(72) Inventor: Panayotis Lekkas, Worcester, MA (US)

(21) Appl. No.: 15/916,059

(22) Filed: Mar. 8, 2018

(51) Int. Cl. H04L 29/06; H04L 9/14; H04L 9/32

(52) U.S. Cl. CPC H04L 63/0876; H04L 63/0428; H04L 63/20; G05D 1/0088; H04L 63/0823; H04L 9/3268; H04L 9/14

(57) ABSTRACT

Systems and methods for securing a select vehicle's automotive controller network are described. Embodiments introduce a pass-through security module with a first interface physically coupled to an unsecured access port to the automotive controller network and configured to communicatively couple or decouple with the access port based on a determination of whether network access requests received by a second interface of the security module from an external device are authorized to interact the automotive controller network. Authorization determinations may be made by the security module in conjunction with a telematics control unit and/or a remote server in accordance with one or more security policies. The security module may further use the one or more security policies to impose an encryption infrastructure on the automotive controller network to facilitate sender identification and data frame authenticity.

### CROSS-REFERENCE TO RELATED APPLICATIONS

The present application is related to co-pending and commonly assigned U.S. patent application Ser. No. 15/845,859 entitled, “SYSTEMS AND METHODS FOR USING AN OUT-OF-BAND SECURITY CHANNEL FOR ENHANCING SECURE INTERACTIONS WITH AUTOMOTIVE ELECTRONIC CONTROL UNITS,” filed on Dec. 18, 2017, which is hereby incorporated by reference herein.

### TECHNICAL FIELD

The present application is generally related to automotive electronics, and more particularly to securing an automotive controller network such as from unauthorized or malicious access.

### BACKGROUND OF THE INVENTION

Modem vehicles contain a multitude of microprocessors or electronic control units (ECU). Each ECU may be supported by memory and effectively operates as an autonomous computer responsible for controlling automotive systems. For example, ECUs may control critical vehicle operations such as fuel injection, emissions, throttle, transmission, exterior lighting, braking, and traction systems. ECUs may also control safety and/or comfort systems such as supplemental restraint systems (e.g., air bags, seat belts, or other safety devices), climate control, cruise control, navigation, audio, video, and blind spot monitoring. While some of these ECUs may be independent subsystems, communication among ECUs is often essential to the overall function of a vehicle. For example, the functionality of a particular ECU may require that it interact with other ECUs (e.g., control actuators, receive feedback from sensors, etc.) dispersed throughout the vehicle.

An automotive controller network, such as a controller area network (CAN), is typically used to connect nodes (e.g., individual ECUs and their supporting electronics) together to facilitate inter-communication. The CAN communications protocol is commonly used within modern vehicles and is often implemented as a multi-master serial bus. A key advantage of the CAN bus is that interconnection between various nodes allows for a wide range of safety, economy, and convenience features to be implemented using software alone—without the need for dedicated wiring between each node or a dedicated computer (e.g., bus master) to route communications from one node to another. Each node is able to send and receive messages via the CAN bus, although not simultaneously. A message (i.e., data frame) often includes an identifier, which is used to prioritize data frame collisions on the CAN bus, and several data bytes. Data frames may be transmitted serially onto the CAN bus and may be received by all nodes connected to the CAN bus.

Typically, an ECU is connected to a CAN bus through a chain of logical architectural blocks and comprises a host processor, a CAN controller, and a CAN transceiver. The host processor (e.g., central processing unit, microprocessor, microcontroller, etc.) of the ECU, besides executing control operations related to a corresponding automotive subsystem managed by the ECU, processes received messages and prepares messages for transmission. The CAN controller (e.g., a separate microcontroller or an integrated portion of the host processor) stores serially received, data frame bits from the CAN bus until an entire message is available; once available the CAN controller may provide the received message to the host processor. The CAN controller may also receive messages from the host processor, which the CAN controller may transmit onto the CAN bus via the CAN transceiver. CAN transceivers, which typically include circuitry designed to protect the CAN controller, convert received data streams (e.g., bit streams forming one or more data frames) from CAN bus levels to levels that the CAN controller can process and converts transmitted data streams from the CAN controller to CAN bus levels. Messages are transmitted to and received from the CAN bus as serially transmitted bits.

However, CAN is a low-level protocol that does not intrinsically support security features. Conventional CAN implementations do not use encryption and are vulnerable to man-in-the-middle packet interception and/or insertion. Typically, ECUs on a CAN bus are expected to deploy their own security mechanisms (e.g., authenticate incoming commands, detect the presence of certain devices on the network, etc.). Failure to implement adequate security measures leaves the CAN bus and any ECUs connected to the CAN bus vulnerable to attack, such as a malevolent actor inserting malicious data (e.g., instructions, code, firmware, etc.) on the CAN bus. Because CAN buses often lack a bus master, any malicious attacks asserted by a node with access to the CAN bus (e.g., an external device coupled to a diagnostic port, a compromised Bluetooth radio ECU, an worm-infected ECU, etc.) may be broadcast to every node on the CAN bus. While encryption may exist for some safety-critical functions, such as modifying firmware, programming ECU instructions, or controlling an ECU, these systems are not universally implemented. Furthermore, since data frames on the CAN bus typically do not contain sender identification, ECUs connected to the CAN bus may be unable to authenticate or ascertain the legitimacy of received data frames. ECUs are also unable to ascertain whether received data frames have been tampered with due to the lack of cryptography (e.g., encrypted data frames, digital signatures, etc.) on the CAN bus.

Further complicating matters, most vehicles are equipped with an access port (e.g., diagnostic port, etc.) designed to provide direct access to the CAN bus and, as a result, all ECUs within a vehicle. Typically, access ports are passive ports that do not offer authentication or security protections. While these access ports are commonly used by technicians for diagnostics and to facilitate repairs, vehicle owners often attach external radios (e.g., Wi-Fi, Bluetooth, LTE, etc.) to the access ports in order to obtain access to real time performance data. Similarly, many modern vehicles come equipped with external radio ECUs (e.g., Bluetooth transceiver, satellite modems, LTE cellular transceiver, Wi-Fi transceiver, etc.) directly connected to the CAN bus. Introducing an external radio, even a legitimate device, to an unsecured access port or directly to the CAN bus provides malevolent actors with a potential delivery vector for inserting malicious data onto or spoofing data frames within the CAN bus.

### BRIEF SUMMARY OF THE INVENTION

The present invention is directed to methods and systems for securing an automotive controller network using a security module physically and communicatively coupled to an access port of a select vehicle's automotive controller network and a corresponding access authority in communication with the security module. Embodiments of the present invention provide a secured gatekeeper to the vehicle's automotive controller network, which substantially eliminates or reduces disadvantages and problems with previous systems and methods.

In accordance with embodiments of the present invention, a pass-through security module with a first interface and a second interface is used to provide security enhancements to the automotive controller network by eliminating vulnerabilities inherent to automotive controller networks and/or associated with unsecured access ports. The first interface may be coupled to an access port to an automotive controller network and may be configurable in an operationally enabled state (e.g., physically and communicatively coupled with the access port) or an operationally disabled state (e.g., physically coupled but communicatively decoupled with the access port). The second interface may be configured to couple with an external device seeking to interact with one or more nodes (e.g., individual ECUs and their supporting electronics) on the automotive controller network and may be configurable in an operationally enabled state (e.g., physically and communicatively coupled with the external device) or an operationally disabled state (e.g., physically coupled but communicatively decoupled with the external device). In accordance with embodiments, when both interfaces of the security module are operationally enabled, signals received from the external device at the second interface may be relayed through the first interface to the access port and ultimately the automotive controller network. When either interface of the security module is operationally disabled according to embodiments, signals received at the disabled interface may not be relayed. Preferably, the default operational state for the first interface is operationally disabled, and the default operational state for the second interface is operationally enabled.

In accordance with embodiments of the present invention, an access authority may be used in conjunction with the security module to provide security enhancements to the automotive controller network. The access authority preferably is configured to authorize any attempts to interact with the automotive controller network via the security module and the access port and to modify the operational states of the first and/or second interfaces of the security module. The access authority of embodiments may periodically or aperiodically communicate with the security module to monitor for the continued presence of the security module on the automotive controller network (e.g., the security module has not been physically decoupled from the access port, the security module has not malfunctioned, etc.) and enact mitigating actions if the security module is no longer present (e.g., transmit a notification to the owner of the vehicle or a designated proxy, trigger an alarm, etc.). In this way, the security enhancements afforded by the security module may not be defeated by simply removing the security module. In some embodiments, the access authority may include a telematics control unit communicatively coupled to the automotive controller network. Additionally or alternatively, the access authority may include a remote server communicatively coupled to the security module.

In operation according to embodiments, the security module may receive a network access request (e.g., a write operation, a read operation, a physically and communicatively coupling event with respect to the security module, etc.) from the external device at the second interface. The first interface, which is preferably in the operationally disabled state, may prevent the network access request from interacting with the access port to the automotive controller network. To ensure that the network access request is not malicious, the security module may transmit an access notification containing information associated with the network access request and, preferably, an identifier associated with the external device (received by the security module along with the network access request and/or in response to a request by the security module to the external device) to the access authority. The access authority of embodiments may apply security policies (e.g., whitelists, security rules, etc.) to the information of the access notification to determine whether the network access request and/or the external device is authorized to interact with the automotive controller network. Once the access authority determines the authorization status of the network access request and/or the external device, the access authority may transmit an access command to the security module to facilitate disposition of the network access request.

In accordance with one aspect of the present invention, the access command of embodiments may identify whether the network access request is authorized or unauthorized to interact with the automotive controller network and provide operational instructions for the security module. For example, if the access command indicates that the network access request is authorized, the security module may operationally enable the first interface and permit the network access request to be relayed to the automotive controller network via the access port. However, if the access command indicates that the network access request is unauthorized, the security module may, for example, operationally disable the second interface to prevent further interactions with the external device. In some embodiments, the access command may include excerpts of the security polices, particularized to the external device, thereby enabling the security module to determine whether subsequent network access requests from the external device are authorized, without needing to transmit a subsequent access notification to the access authority. Accordingly, instead of the open-door policy prevalent among conventional access ports and automotive controller networks, the security module, access authority, and security policies of embodiments ensures that only authorized actors and/or actions may interact with the automotive controller network.

In some embodiments, the security module and/or the access authority may monitor data frame transmissions on the automotive controller network to detect malicious code (e.g., embedded in one or more compromised data frames). If any compromised data frames are detected, the security module and/or the access authority may act to mitigate or prevent the damage caused by the malicious code (e.g., transmit colliding data frames to block receipt of the one or more compromised data frames by any ECUs communicatively coupled to the automotive controller network, transmit regularly-backed-up images of one or more of the plurality of ECUs to overwrite changes by the malicious code, etc.). In this way, even if a malevolent actor were to bypass the security module and inject malicious code onto the automotive controller network through a compromised ECU node (e.g., Bluetooth radio ECU, Wi-Fi ECU, universal serial bus (USB) ECU, a directly connected external device spliced into the automotive controller network, etc.), the security module and/or the access authority may detect the malicious code and act to protect the automotive controller network.

In some embodiments, the security module and/or the access authority may be configured to impose an encryption infrastructure on the automotive controller network by assigning vehicle encryption keys and/or digital certificates to a plurality of nodes (e.g., one or more nodes, all nodes, operationally critical nodes, etc.) on the automotive controller network. An encryption infrastructure according to embodiments may allow each node to identify the sending node of a received data frame and mitigate the risk of receiving malicious code (e.g., malicious instructions, tampered instructions, etc.). In additional embodiments, the security module may be configured with passive tamper prevention such as, for example, security seals (e.g., tamper-proof adhesives, locking mechanisms, etc.) suitable for preventing removal (e.g., physical decoupling) of the security module from the access port, and/or active tamper prevention such as, for example, detecting an instantaneous loss of power received from the automotive controller network associated with physical decoupling the security module from the access port and subsequently engaging an applicable security policy. Should the security module be removed from the access port, the security module is preferably configured to log and/or provide notifications regarding unsecured status of the automotive controller network.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 illustrates a block diagram of a system for securing an automotive controller network from unauthorized access, in accordance with embodiments of the invention;

FIGS. 2A and 2B illustrate block diagrams of a process for securing an automotive controller network from unauthorized access, in accordance with embodiments of the invention;

FIG. 3 illustrates a block diagram of a system for securing an automotive controller network from unauthorized access, in accordance with embodiments of the invention;

FIGS. 4A and 4B illustrate block diagrams of a process for securing an automotive controller network from unauthorized access, in accordance with embodiments of the invention; and

FIG. 5 illustrates a flow diagram for securing an automotive controller network from unauthorized access, in accordance with embodiments of the invention.

### DETAILED DESCRIPTION OF THE INVENTION

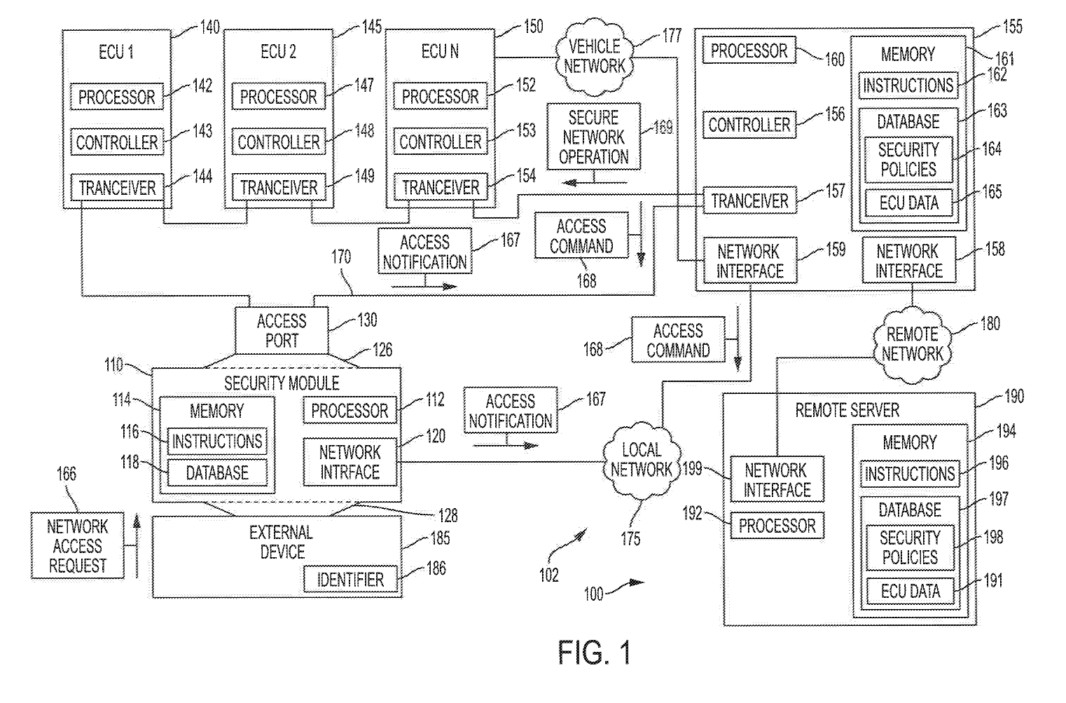

Referring to FIG. 1, an embodiment of a system for securing an automotive controller network from unauthorized access is shown as system 100. As depicted in FIG. 1, system 100 may include vehicle 102, security module 110, access port 130, ECU nodes 140, 145, and 150, telematics control unit (TCU) 155, and remote server 190. Access port 130 may be communicatively coupled to ECU nodes 140, 145, and 150 and TCU 155 via automotive controller network 170. Security module 110 may be physically and communicatively coupled to access port 130 and, by extension, may be communicatively coupled to ECU nodes 140, 145, and 150 and TCU 155 via automotive controller network 170. Security module 110 may also be communicatively coupled to TCU 155 via local network 175. TCU 155 may also be communicatively coupled to remote server 190 via remote network 180. In some embodiments, TCU 155 and/or one or more ECUs (e.g., one or more of ECU nodes 140, 145, and 150) may be communicatively coupled to vehicle network 177.

According to embodiments, security module 110, access port 130, ECU nodes 140, 145, and 150, and TCU 155 may be installed within vehicle 102. It is noted that system 100 is discussed herein with respect to a single vehicle (e.g., vehicle 102) for purposes of illustration, rather than by way of limitation, and, in other embodiments, system 100 may be implemented with respect to a plurality of vehicles or even an entire fleet of vehicles. In some embodiments, vehicle 102 may include electric vehicles, diesel combustion vehicles, gasoline combustion vehicles, autonomous vehicles, or other forms of personal and mass transportation. In additional embodiments, vehicle 102 may include trains, boats, ships, submarines, planes, or other forms of non-automotive (manned or autonomous) transportation. Although embodiments and examples described herein involve modes of transportation, it should be appreciated that the concepts described herein may be used to likewise secure functionally similar controller networks in other autonomous devices, such as sensor buoys, autonomous probes, autonomous drones, etc.

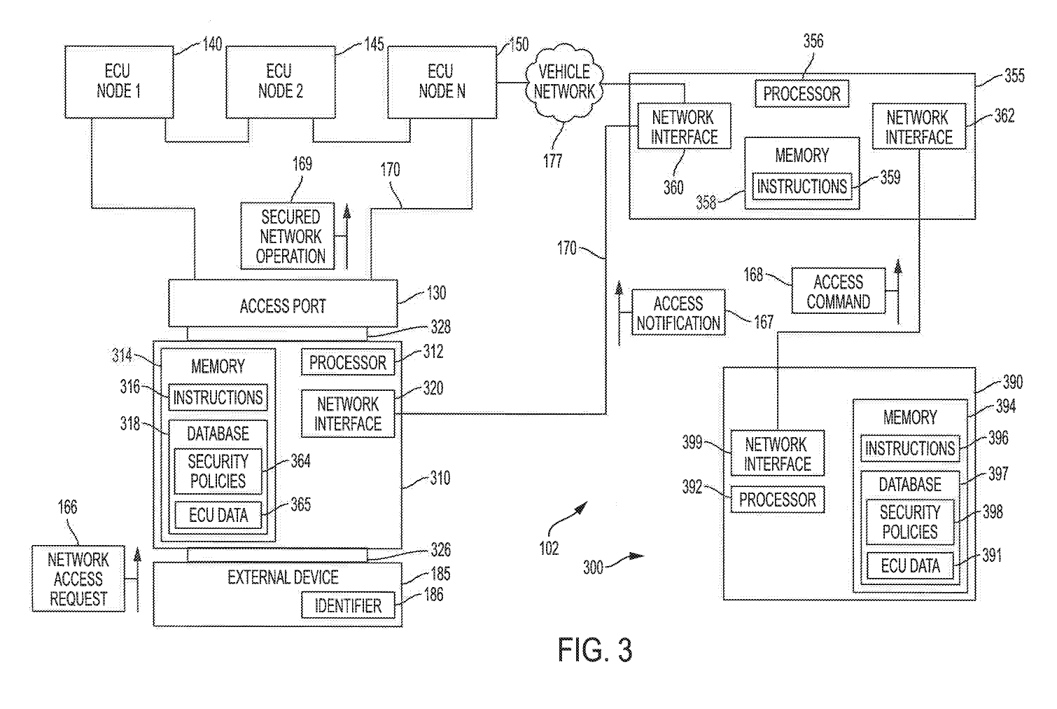

Automotive controller network 170 of embodiments may be an internal communications protocol and infrastructure that interconnects components inside vehicle 102 and may include, for example, Controller Area Network (CAN), Local Interconnect Network (LIN), Multifunction Vehicle Bus, Domestic Digital Bus (D2B), DC-BUS, Media Oriented Systems Transport (MOST), Vehicle Area Network (VAN), automotive Ethernet, other communications topologies and protocols suitable for interconnecting ECUs within a vehicle, or combinations thereof. In operation according to embodiments, automotive controller network 170 facilitates communication between and supplies power to a plurality of ECU nodes (e.g., ECU nodes 140, 145, and 150), TCU 155, access port 130, security module 110 (and corresponding security module 330 of FIG. 3), and any devices interacting with access port 130 via security module 110 (e.g., external device 185).

A plurality of ECUs are depicted in FIG. 1 as including first ECU node 140, second ECU node 145, and Nth ECU node 150. In operation according to embodiments, each ECU node (e.g., a select node of ECU nodes 140, 145, and 150) comprise a host processor (e.g., a corresponding host processor of host processors 142, 147, and 152), a communication controller (e.g., a corresponding communication controller of communication controllers 143, 148, and 153), and a transceiver (e.g., a corresponding transceiver of transceivers 144, 149, and 154). ECUs of embodiments may be classified according to different automotive domains such as engine systems, transmission systems, chassis electronics, active safety systems, driver assistance systems, passenger comfort systems, and infotainment systems. Each ECU node may be communicatively coupled to automotive controller network 170, and all other components connected to automotive controller network 170 (e.g., other ECU nodes, TCU 155, access port 130, and security module 110, etc.), via its respective transceiver. In some embodiments, one or more ECUs (e.g., one or more of ECU nodes 140, 145, and 150) may be communicatively coupled to vehicle network 177, as discussed below, and may provide one or more external devices communicatively coupled to vehicle network 177 with access to automotive controller network 170. For example, ECU node 150 may be a Bluetooth interface communicatively coupled to vehicle network 177, and any external Bluetooth devices coupled to vehicle network 177 may have access to automotive controller network 170 via ECU node 150. It is noted that, in FIG. 1, automotive controller network 170 is shown as being communicatively coupled to three ECU nodes for purposes of illustration, rather than by way of limitation, and, in other embodiments of system 100, automotive controller network 170 may be communicatively coupled to more than three or less than three ECU nodes. Furthermore, while embodiments and examples described herein may refer to ECU nodes 140, 145, or 150, individually, it should be appreciated that the concepts herein may likewise apply to a plurality of ECU nodes or even all ECU nodes (e.g., ECU nodes 140, 145, and 150) within vehicle 102.

In accordance with embodiments, local network 175 preferably includes one or more in-vehicle, local wireless networks such as, for example, Wi-Fi, wireless USB, Bluetooth, other network infrastructures and topologies suitable for wireless connectivity within vehicle 102, or combinations thereof. In some embodiments, local network 175 may interconnect security module 110 and TCU 155. In further embodiments, local network 175 may include wired connections such as, for example, coaxial cables, optical fiber cables, twisted pair cables, any other type of cables suitable for operations described herein, or combinations thereof. Additionally or alternatively, local network 175 may interconnect security module 110 and a network relay (e.g., network relay 355 of FIG. 3).

Vehicle network 177 of embodiments may be configured to provide external access to one or more ECUs (e.g., one or more of ECU nodes 140, 145, and 150) of vehicle 102 and, as a byproduct, access to automotive controller network 170. In some embodiments, vehicle network 177 may include in-vehicle wireless communication networks such as, for example, Wi-Fi, wireless USB, Bluetooth, other network infrastructures and topologies suitable for wireless communication with one or more ECUs (e.g., one or more of ECU nodes 140, 145, and 150) of vehicle 102, or combinations thereof. For example, ECU node 150 may be a Bluetooth radio configured to communicatively couple with external devices over Bluetooth (e.g., a communication channel of vehicle network 177). In additional or alternative embodiments, vehicle network 177 may include wired communications networks such as, for example, USB, lightning, thunderbolt, any other communication infrastructures and topologies suitable for wired communication with one or more ECUs (e.g., one or more of ECU nodes 140, 145, and 150) of vehicle 102, or combinations thereof. For example, ECU Node 150 may be a USB hub configured to communicatively couple with external devices over one or more USB cables (e.g., a communication channel of vehicle network 177). Vehicle network 177 of embodiments is preferably communicatively coupled to TCU 155, which may be configured as a network bridge providing access to the one or more ECUs. In this way, TCU 155 may apply security policies 164, as discussed below, to determine whether the external devices communicatively coupled to vehicle network 177 are authorized to access automotive controller network 170. For example, TCU 155 may include a Bluetooth radio configured to transmit authorized operations and/or information received from external devices over vehicle network 177 (e.g., music, etc.) to ECU Node 140 (e.g., stereo system, etc.) via automotive controller network 170. Additionally or alternatively, vehicle network 177 may be communicatively coupled to one or more ECUs (e.g., one or more of ECU nodes 140, 145, and 150) and TCU 155 may apply security policies 164 to monitor and verify, as discussed below, data frames transmitted onto automotive controller network 170 by any external devices communicatively coupled to the one or more ECUs via vehicle network 177.

In accordance with embodiments, remote network 180 may include one or more communications networks for facilitating external communications to and from vehicle 102. For example, remote network 180 may include one or more data networks and/or one or more security networks. Data networks of remote network 180 may include wired networks, wireless networks, local area networks (LANs), wireless LANs (WLANs), wide area networks (WANs), metropolitan networks (MANs), Wi-Fi networks, Worldwide Interoperability for Microwave Access (WiMAX) networks, public networks (e.g., the Internet), private networks (e.g., home wireless and/or wired network associated with the owner of vehicle 102), cellular broadband networks (e.g. LTE, CDMA200, EDGE, 5G wireless, etc.), multi-network mobile virtual network operator (MVNO) networks, ultra-high frequency (UHF) Advanced Television Systems Committee (ATSC) networks, radio frequency (RF) networks, geostationary (GEO) satellite networks (e.g., Ku-band satellite networks, Ka-band satellite networks, etc.), other network infrastructures and topologies suitable for content delivery, or combinations thereof.

According to embodiments, security networks of remote network 180 may, for example, comprise a satellite constellation network, such as a low-Earth orbit (LEO) Ku-band satellite constellation network, an LEO Ka-band satellite constellation network, an LEO L-band satellite constellation network, a Walker Delta Pattern satellite constellation network, a Walker Star satellite constellation network, a V-band low-Earth orbit (VLEO) satellite constellation network, other out-of-band network infrastructures and topologies suitable for providing cryptographic enhancements to in-band communications via the one or more data networks, or combinations thereof. For example, cryptographic communications via one or more out-of-band, side-channel security networks of remote network 180 may be used to enhance the security of in-band vehicle data communications via one or more data networks of remote network 180, such as shown and described in the above referenced U.S. patent application entitled “SYSTEMS AND METHODS FOR USING AN OUT-OF-BAND SECURITY CHANNEL FOR ENHANCING SECURE INTERACTIONS WITH AUTOMOTIVE ELECTRONIC CONTROL UNITS.”

Access port 130 of embodiments may be a standardized digital communications interface configured to provide access to automotive controller network 170 and any components communicatively coupled to automotive controller network 170 (e.g., TCU 155, ECU nodes 140, 145, and 150, etc.). For example, access port 130 may include an OBD-II port, an European on board diagnostics (EOBD) port, a Japanese On-Board Diagnostics (JOBD) port, any other type of standardized interface suitable for providing an external device (e.g., external device 185) with access to automotive controller network 170, or combinations thereof.

External device 185 of embodiments may be configured to physically and communicatively couple with access port 130 and may include simple consumer tools (e.g., handheld diagnostic scanners, Bluetooth dongles, Wi-Fi dongles, etc.), sophisticated technician tools (e.g., calibration tools, bidirectional diagnostic scopes, etc.), any other tools designed for interacting with automotive controller network 170, or combinations thereof. External device 185 preferably includes identifier 186 to facilitate determination of whether external device 185 is authorized to interact with automotive controller network 170. Identifier 186 may include user credentials associated with the user of external device 185, software licenses, pre-authorized passcodes, any other type of verifiable identification suitable for transmission to security module 110, or combinations thereof. In some embodiments, identifier 186 may be locally stored within external device 185. For example, external device 185 may be a technician's scanning tool and identifier 186 may be the technician's certification stored within a memory component of the scanning tool (e.g., external device 185). Additionally or alternatively, identifier 186 may be remotely stored with respect to external device 185. For example, external device 185 may be an external radio (e.g., Bluetooth, Wi-Fi, etc.) dongle installed by the owner of vehicle 102 to monitor engine performance. In this example, identifier 186 may be a software license stored in association with a pre-authorized monitoring application running on a remote device (e.g., smartphone, tablet, any other mobile device, etc.) communicatively coupled to the external radio.

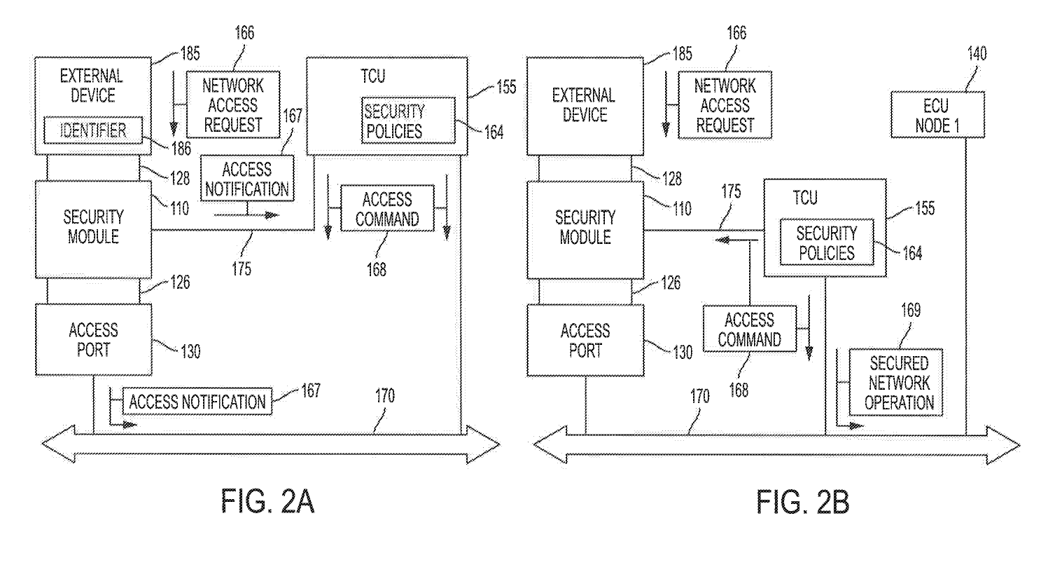

In operation, external device 185 may initiate network access request 166. Network access request 166 of embodiments may include, for example, a write operation to ECU Node 140, a read operation from ECU Node 140, a physically and communicatively coupling event with respect to security module 110, any other actions taken by external device 185 to interact with automotive controller network 170 via access port 130, or combinations thereof. Preferably, network access request 166 also includes identifier 186 to facilitate determination that network access request 166 is authorized to interact with automotive controller network 170. Additionally or alternatively, external device 185 may provide identifier 186 to security module 110 in response to a request from security module 110. In some embodiments, network access request 166 may be determined as authorized even if identifier 186 is not available and/or provided if TCU 155 determines, based on security policies 164, that network access request 166 is benign (e.g., read operation for a non-critical system, etc.), as discussed below with respect to FIGS. 2A and 2B.

Security module 110 of embodiments is preferably a pass-through adapter and may include processor 112, memory 114, internal network interface 120, first interface 126, and second interface 128. Security module 110 preferably receives power from automotive controller network 170 via access port 130. In some embodiments, security module 110 may include an internal power supply (e.g., button cell battery, coin cell battery, watch cell battery, etc.) suitable for ensuring that security module 110 may continue to perform operations described herein even if physically decoupled from access port 130 and automotive controller network 170. Processor 112 may include a single processor, or multiple processors, each of which may include a single processing core, multiple processing cores, or combinations thereof. In operation according to embodiments, processor 112 may be configured to perform functions as described herein (e.g., selectively deny access to automotive controller network 170 via access port 130, monitor data frame transmissions via automotive controller network 170, monitor physical coupling status with access port 130, establish and/or validate an encryption infrastructure on automotive controller network 170, etc.). Preferably, any registers or other form of operational storage (e.g., cache, etc.) of processor 112 are zeroizable upon detection of certain conditions such as, for example, a disconnect of security module 110 from automotive controller network 170 and/or catastrophic power outage on automotive controller network 170, thereby preventing malicious reverse-engineering of the internal state of processor 112.

Memory 114 of embodiments may include random access memory (RAM) devices, read-only memory (ROM) devices, flash memory devices, other memory devices configured to store information in a persistent or non-persistent state and suitable for operations described herein, or combinations thereof. In operation according to embodiments, memory 114 may store instructions 116 that, when executed by processor 112, cause processor 112 to perform functions as described herein. In some embodiments, memory 114 may store database 118 containing information that may be used to support the operations of security module 110. In accordance with embodiments, exemplary information stored at database 118 and used to support the operations of security module 110 may include information associated with network access request 166 (e.g., nature and/or timing of the network access request, identity of an ECU that external device 185 seeks to interact with, identifier 186, etc.), incident logs associated with the connection status between security module 110 and access port 130, and one or more received access commands (e.g., one or more of access command 168 of FIGS. 2A and 2B). Memory 114 is preferably encrypted to prevent tampering and/or modification by external device 185.

First interface 126 of embodiments may correspond to the standardized interface of access port 130 and may be configured to physically and communicatively couple with access port 130. In some embodiments, first interface 126 may be configured with security seals (e.g., tamper-proof adhesives, locking mechanisms, etc.) suitable for preventing removal (e.g., physical decoupling) of security module 110 from access port 130. Second interface 128 of embodiments may also correspond to the standardized interface of access port 130 and may be configured to physically and communicatively couple with external device 185. In operation according to embodiments, when first interface 126 and second interface 128 are operationally enabled (e.g., physically and communicatively coupled with access port 130 and external device 185, respectively), external device 185 may interact with automotive controller network 170 via security module 110 and access port 130 (e.g., send and/or receive data frames, etc.), while security module 110 preferably monitors these interactions to ensure that they are authorized (e.g., a new interaction type that was not previously authorized, etc.) and not malicious (e.g., detecting the presence of malicious code). However, when first interface 126 is operationally disabled (e.g., physically coupled but communicatively decoupled with access port 130), as discussed below with respect to FIGS. 2A and 2B, network access request 166 from external device 185 is preferably received by security module 110 but not relayed to access port 130 and/or automotive controller network 170. When second interface 128 is operationally disabled (e.g., physically coupled but communicatively decoupled with external device 185) according to embodiments, external device 185 preferably is unable to transmit signals (e.g., network access request 166 or other data frames intended for automotive controller network 170) to or read signals from security module 110.

Internal network interface 120 of embodiments may include a Wi-Fi transceiver, a wireless USB transceiver, a Bluetooth transceiver, other wired and/or wireless protocol interfaces suitable for connectivity within vehicle 102, or combinations thereof. In operation, internal network interface 120 may communicatively couple security module 110 with local network 175 to facilitate communication with TCU 155 via local network 175. In some embodiments, communication between security module 110 and TCU 155 via internal network interface 120 may occur in conjunction with or in lieu of communication between security module 110 and TCU 155 via automotive controller network 170. Communication between security module 110 and TCU 155 via internal network interface 120 is preferably encrypted to prevent interception and/or packet sniffing by malevolent actors. It is noted that internal network interface 120 is depicted as a singular interface for purposes of illustration, rather than by way of limitation, and, in other embodiments of system 100, internal network interface 120 may include more than one network interface configured to communicatively couple security module 110 to local network 175.

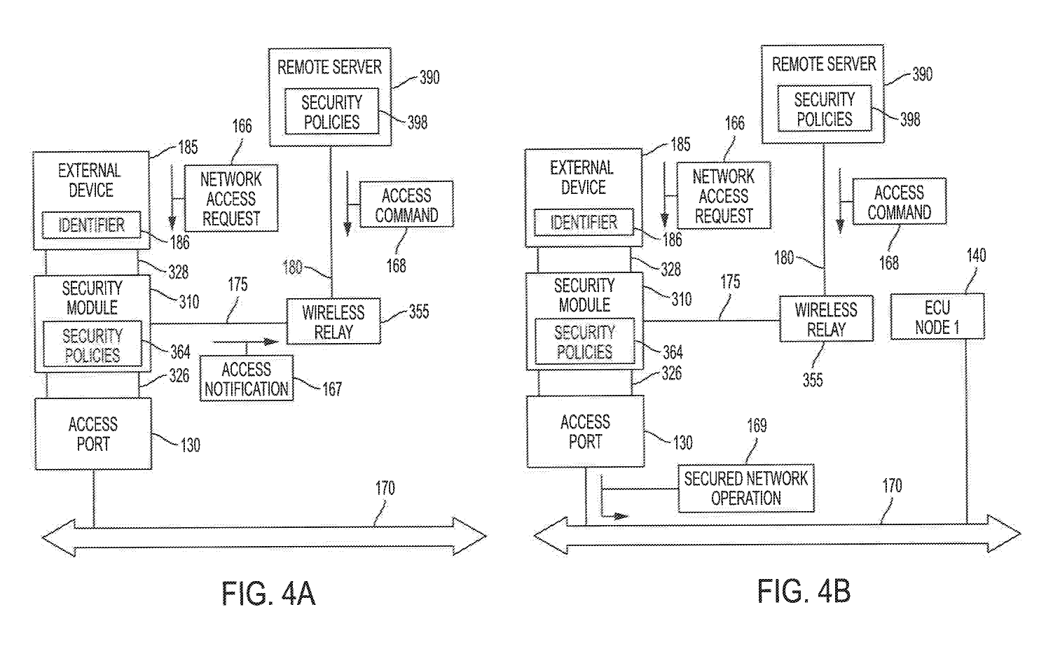

TCU 155 of embodiments is an embedded automotive system that facilitates external communications with vehicle 102 and supports, among other unrelated vehicle operations (e.g., gateway bridging with network-connected infotainment and/or navigation equipment on vehicle network 177, etc.), the operations of security module 110 as described herein. TCU 155 preferably includes communications controller 156 and transceiver 157 to facilitate communication via automotive controller network 170, external network interface 158 to facilitate communication with remote network 180, internal network interface 159 to facilitate communication with security module 110 via local network 175, processor 160, and memory 161. In some embodiments, internal network interface 159 may be communicatively coupled to vehicle network 177 to facilitate communications bridging between one or more external devices communicatively to vehicle network 177 and one or more ECUs (e.g., one or more of ECU nodes 140, 145, and 150) communicatively coupled to automotive controller network 170. In additional or alternative embodiments, TCU 155 may be configured without communications controller 156 and transceiver 157 and, as a result, may interact with automotive controller network 170 via local network 175 and security module 110, as discussed below with respect to FIGS. 3, 4A, and 4B (e.g., corresponding to network relay 355). In some embodiments, an exemplary representation of TCU 155 may be the in-vehicle-system discussed in the above referenced application entitled “SYSTEMS AND METHODS FOR USING AN OUT-OF-BAND SECURITY CHANNEL FOR ENHANCING SECURE INTERACTIONS WITH AUTOMOTIVE ELECTRONIC CONTROL UNITS.” It is noted that external network interface 158 and internal network interface 159 are depicted as a singular interfaces for purposes of illustration, rather than by way of limitation, and, in other embodiments of system 100, external network interface 158 and internal network interface 159 may each include more than one network interface configured to communicatively couple TCU 155 to remote network 180 and TCU 155 to local network 175 and/or vehicle network 177, respectively.

In operation according to embodiments, processor 160 may be configured to perform functions as described herein (e.g., determine whether network access request 166 is authorized to interact with automotive controller network 170 via access port 130, transmit access command 168 to security module 110, monitor data frame transmissions via automotive controller network 170, monitor the physical coupling status of security module 110 with access port 130, etc.). In operation according to embodiments, memory 161 may store instructions 162 that, when executed by processor 160, cause processor 160 to perform functions as described herein. In some embodiments, TCU 155 may initiate secured network operation 169 (e.g., a read and/or write operations to ECU node 140, a firmware update for ECU node 140, delivering DRM-protected media to ECU node 140, etc.) with respect to automotive controller network 170 via communications controller 156 and transceiver 157, as discussed below with respect to FIG. 2B. In additional or alternative embodiments, TCU 155 and/or remote server 190 may initiate secured network operation 169 with respect to automotive controller network 170 via local network 175 and security module 110, as discussed below with respect to FIG. 4B (e.g., secured network operation 169 involving network relay 355 and security module 310).

Memory 161 of embodiments may store database 163 containing information that may be used to support the operations of TCU 155. In accordance with embodiments, exemplary information stored at database 163 and used to support the operations of TCU 155 may include security policies 164 and ECU data 165. ECU data 165 of embodiments may include information associated with ECU nodes 140, 145, and 150 such as, for example, regularly-backed-up images of one or more ECUs (e.g., one or more of ECU nodes 140, 145, and 150) to facilitate recovery and/or repair, as discussed below, and metadata associated with protected data (e.g., software, firmware, code instructions, etc.) installed and/or scheduled for installation (e.g., release version, release date, installation date, etc.) to the one or more ECUs to facilitate coordination with remote server 190 of protected data delivery to vehicle 102. The regularly-backed-up ECU images of embodiments may be received from the ECUs (e.g., one or more of ECU nodes 140, 145, and 150) in response to polling (e.g., nightly, weekly, etc.) by TCU 155 via automotive controller network 170. The metadata of embodiments, may be recorded and/or updated, for example, as protected data is received from remote server 190 and transmitted to the corresponding ECU (e.g., a select ECU of ECU nodes 140, 145, and 150) and/or in response to polling (e.g., nightly, weekly, monthly, etc.) by TCU 155 via automotive controller network 170. In some embodiments, remote server 190 may independently determine whether one or more ECUs (e.g., one or more of ECU nodes 140, 145, and 150) may benefit from receiving protected data and coordinate delivery of the protected data to vehicle 102 with TCU 155. For example, remote server 190 may determine that new firmware (e.g., protected data) is available for ECU node 140 and send a push notification to TCU 155 regarding ECU node 140 and information associated with the new firmware (e.g., release date, release version, file size, etc.). In response, TCU 155 may compare the information of the push notification with metadata of ECU data 165 associated with ECU Node 140, communicate with remote server 190 if TCU 155 detects any discrepancies, coordinate secured (e.g., encrypted, etc.) delivery of the firmware update via remote network 180 with remote server 190, and initiate secured network operation 169, as described below with respect to FIG. 2B, to communicate and install the firmware update to ECU node 140. Additionally or alternatively, TCU 155 may communicate ECU data 165 associated with one or more ECUs (e.g., one or more of ECU nodes 140, 145, and 150) to remote server 190 via remote network 180 to facilitate a determination by remote server 190, in conjunction with ECU data 191 as discussed below, whether to deliver protected data to vehicle 102 via remote network 180 and TCU 155.

Security policies 164 of embodiments may include, for example, whitelists, security rules, digital certificates, vehicle encryption keys, and/or vehicle seed parameters. In some embodiments, security policies 164 may be received from remote server 190 via remote network 180 and may correspond to security policies 198 of remote server 190. Additionally or alternatively, security policies 164 may be stored in database 163 by the manufacturer of vehicle 102 or a designated proxy. Whitelists of embodiments may include lists of authorized external devices (e.g., one or more of external device 185), authorized users associated with the authorized external devices, and/or authorized operations associated with authorized external devices and/or users, as discussed below with respect to FIG. 2A. According to embodiments, the digital certificates, vehicle encryption keys, and/or vehicle seed parameters of security policies 164 may be used by TCU 155 to establish and/or validate portions of or a totality of an encryption infrastructure on automotive controller network 170, as discussed below.

In some embodiments, security policies 164, and corresponding security policies 198 of remote server 190, may be identical across multiple vehicles (e.g., a plurality of vehicle 102, a fleet of vehicle 102, etc.). For example, if a particular diagnostic tool is recognized as having a security vulnerability, security policies (e.g., a plurality of security policies 164) may be universally implemented for vehicles (e.g., a plurality of vehicle 102) equipped with security module 110 and TCU 155 such that any network access requests (e.g., one or more of network access request 166) from the vulnerable tool (e.g., external device 185) may be determined as unauthorized. In additional or alternative embodiments, security policies 164 may be particularized to an individual vehicle (e.g., a select vehicle 102). For example, owner A of vehicle A may have installed a Bluetooth radio dongle onto security module 110 and registered a diagnostic application on owner A′s smartphone with remote server 190. Thus, security policies 164 particularized to owner A and vehicle A may indicate that network access requests (e.g., one or more of network access request 166) from the registered diagnostic application (e.g., identifier 186) via the Bluetooth radio dongle (e.g., external device 185) are authorized. However, if owner B of vehicle B similarly installs a Bluetooth radio dongle without an independent identifier onto security module 110 but does not register any applications with remote server 190, any network access requests (e.g., one or more of network access request 166) may be determined, in accordance with security policies 164 of embodiments particularized to owner B and vehicle B, to be unauthorized.

Remote server 190 of embodiments may include processor 192, memory 194, and network interface 199 to facilitate communication with remote network 180. It is noted that network interface 199 is depicted as a singular interface for purposes of illustration, rather than by way of limitation, and, in other embodiments of system 100, network interface 199 may include more than one network interface configured to communicatively couple remote server 190 to remote network 180. In operation according to embodiments, processor 192 may be configured to perform functions as described herein (e.g., support and/or supplement the operations of TCU 155 with respect to security module 110, provide security policies to TCU 155, provide encrypted communication of protected data to TCU 155, etc.). Memory 194 of embodiments may include RAM devices, ROM devices, flash memory devices, hard disk drives (HDD), solid state drives (SSDs), other memory devices configured to store information in a persistent or non-persistent state, or combinations thereof. In operation according to embodiments, memory 194 may store instructions 196 that, when executed by processor 192, cause processor 192 to perform functions as described herein. For example, remote server 190 may provide security policies 164 to TCU 155 via remote network 180 to enable TCU 155 to determine whether a network access request received by security module 110 (e.g., network access request 166) is authorized. In another example, remote server 190 may provide, as discussed in the above referenced application entitled “SYSTEMS AND METHODS FOR USING AN OUT-OF-BAND SECURITY CHANNEL FOR ENHANCING SECURE INTERACTIONS WITH AUTOMOTIVE ELECTRONIC CONTROL UNITS,” encrypted firmware updates via an in-band data network of remote network 180 and encrypted encryption key via an out-of-band security network of remote network 180 to TCU 155. In some embodiments, the functionality of remote server 190 may be implemented on a single server. In alternative embodiments, the functionality of remote server 190 may be implemented across multiple servers.

In an embodiment, memory 194 may store database 197 containing information that may be used to support the operations of remote server 190. Database 197 of embodiments, or a portion thereof, may be stored at a memory external to remote server 190, such as a network attached storage device, a remote database server, other devices accessible to remote server 190, or combinations thereof. In accordance with embodiments, exemplary information stored at database 197 and used to support the operations of remote server 190 may include protected data, encryption keys and/or seed parameters to facilitate communication with TCU 155, security policies 198, and ECU data 191. Protected data of embodiments may include data (e.g., software, firmware, other control instructions, etc.) updates for automotive ECUs, any other form of data content for which protection is provided by embodiments of the invention to prevent unauthorized use or modification, or combinations thereof. The encryption keys (e.g., first-tier encryption keys, second tier encryption asymmetric keys, second tier encryption symmetric keys, etc.) and/or seed parameters (e.g., shared secret suitable for establishing a common algorithmic mode of cryptographic operation to facilitate generation of encryption keys) may be used to encrypt transmissions between remote server 190 and TCU 155.

ECU data 191 of embodiments may include information associated with ECU nodes 140, 145, and 150 such as, for example, regularly-backed-up images of one or more ECUs (e.g., one or more of ECU nodes 140, 145, and 150) to facilitate recovery and/or repair, as discussed below, and metadata associated with protected data (e.g., software, firmware, code instructions, etc.) installed and/or scheduled for installation (e.g., release version, release date, installation date, etc.) to the one or more ECUs to facilitate coordination with TCU 155 of protected data delivery to vehicle 102. In operation according to embodiments, remote server 190 may use ECU data 191 to independently determine whether one or more ECUs (e.g., one or more of ECU nodes 140, 145, and 150) may benefit from receiving protected data and coordinate delivery of the protected data to vehicle 102 with TCU 155, as discussed above with respect to TCU 155 and ECU data 165. In some embodiments, remote server 190 may transmit information of ECU data 191 associated with one or more ECUs (e.g., one or more of ECU nodes 140, 145, and 150) of vehicle 102 to TCU 155 via remote network 180 to facilitate harmonization of ECU data 191 and ECU data 165 by TCU 155. In additional or alternative embodiments, remote server 190 may receive information of ECU data 165 associated with one or more ECUs (e.g., one or more of ECU nodes 140, 145, and 150) of vehicle 102 from TCU 155 via remote network 180 to facilitate harmonization of ECU data 191 and ECU data 165 by remote server 190. It is noted that ECU data 191 is discussed herein with respect to a single vehicle (e.g., vehicle 102) for purposes of illustration, rather than by way of limitation, and, in other embodiments, ECU data 191 may be implemented with respect to a plurality of vehicles or even an entire fleet of vehicles and include vehicle information (e.g., make, model, vehicle identification number (VIN), etc.) for each of the plurality of vehicles and corresponding back-up images and/or protected data versions for each vehicle.

Security policies 198 of embodiments may correspond to security policies 164 of TCU 155 of vehicle 102. In operation according to embodiments, remote server 190 may transmit security policies 198 via remote network 180 to TCU 155 to be stored as security policies 164. In some embodiments, remote server 190 may transmit security policies 198 in a periodic interval (e.g., nightly, weekly, monthly, etc.). Additionally or alternatively, remote server 190 may transmit security policies 198 aperiodically (e.g., in response to a request from TCU 155, in response to a newly identified security vulnerability associated with one or more external devices, etc.)

FIGS. 2A and 2B depict operations of system 100 of FIG. 1 in accordance with an example implementation. In operation according to embodiments, communication between security module 110 and TCU 155 via automotive controller network 170 and local network 175 may be encrypted using the vehicle encryption keys (e.g., assigned or independently generated using a common session secret) of security policies 164 and/or digitally signed using the digital certificates (e.g., assigned by TCU 155) of security policies 164. Security module 110 and TCU 155 of embodiments may mutually communicate with the other via automotive controller network 170, local network 175, or both. Preferably, a digitally signed version of a key exchange protocol (e.g., Diffie-Hellman, etc.) is performed between TCU 155 and security module 110 when security module 110 is initialized (e.g., first coupled to access port 130) to facilitate generation of a common session secret between TCU 155 and security module 110. In some embodiments, the selected communication channel between security module 110 and TCU 155 may be based on a pre-determined sequence. For example, security module 110 and TCU 155 may establish that every fifth communication occur via both automotive controller network 170 and local network 175, every non-fifth, odd-numbered communication occur via automotive controller network 170, and every non-fifth, even-numbered communication occur via local network 175. Additionally or alternatively, each transmission between automotive controller network 170 and local network 175 may indicate the next selected communication channel upon which a subsequent transmission is to be expected. For example, a first transmission from security module 110 to TCU 155 via automotive controller network 170 may indicate that a subsequent communication should be transmitted via both automotive controller network 170 and local network 175. Thus, any transmission purporting to originate from TCU 155 to security module 110 (or vice-versa) that is not transmitted via both automotive controller network 170 and local network 175 may be deemed inauthentic, and ignored accordingly. However, if the subsequent transmission from TCU 155 to security module 110 takes place over both automotive controller network 170 and local network 175, the transmission may be deemed authentic and used to indicate the next communication channel.

Preferably, first interface 126 of embodiments is operationally disabled (e.g., physically coupled to and communicatively decoupled with access port 130) when security module 110 detects network access request 166 (e.g., a read and/or write instruction from external device 185 intended for ECU node 140, a physical coupling of external device 185 to second interface 128 of security module 110, etc.). In operation according to embodiments, security module 110 may store information associated with network access request 166 in database 118, effectively buffering network access request 166. For example, network access request 166 may be a write instruction to an emissions control ECU (e.g., ECU node 140) and security module 110 may store identifier 186 of external device 185, information indicating that ECU node 140 is the target node for network access request 166, any other information describing the nature and/or timing of network access request 166 suitable for ascertaining whether network access request 166 is authorized, or combinations thereof. In another example, when external device 185 is physically and communicatively coupled to second interface 128, security module 110 may store identifier 186 (e.g., received by security module 110 along with the network access request 166 and/or in response to a request by security module 110 to external device 185) and information indicating that network access request 166 is a coupling event. While network access request 166 is buffered in database 118 according to embodiments, security module 110 may transmit access notification 167 to TCU 155 via automotive controller network 170 and/or local network 175. Access notification 167 preferably includes the information associated with network access request 166 buffered in database 118.

Upon receiving access notification 167 from security module 110, TCU 155 of embodiments may apply security policies 164 to determine whether network access request 166 is authorized. For example, TCU 155 may compare identifier 186 associated with external device 185 and the information associated with network access request 166 contained in access notification 167 to one or more whitelists and security rules of security policies 164 specifying authorized identifiers and authorized operations associated with each authorized identifier. In another example, security rules of security policies 164 may specify that a particular identifier of the one or more whitelists is authorized to interact with automotive controller network 170 at specific points in time (e.g., during a scheduled service appointment for vehicle 102, etc.). If identifier 186 is not listed in one or more whitelists of security policies 164, TCU 155 may determine, according to one or more security rules of security policies 164, that network access request 166 is unauthorized. For example, if identifier 186 is listed in one or more whitelists of security policies 164 but security policies 164 also specify that identifier 186 is only authorized to perform read operations and access notification 167 indicates that network access request 166 is a write operation, TCU 155 may determine that network access request 166 is unauthorized. In yet another example, TCU 155 may determine that network access request 166 is authorized when identifier 186 is listed in and the nature and/or timing of network access request 166 (e.g., a write operation, a read operation, etc.) is also specified in security policies 164. In some embodiments, upon determining that identifier 186 and/or network access request 166 do not comply with security policies 164, TCU 155 may transmit access notification 167 via remote network 180 to remote server 190 to facilitate a determination of whether access request 166 is authorized. For example, security policies 198 of remote server 190 may have been updated to include a new type of external device (e.g., external device 185) and security policies 164 of TCU 155 do not contain security rules and/or whitelists associated with the new device, and TCU 155 may transmit access notification 167 to remote server 190 so that remote server 190 may use security policies 198 to determine whether network access request 166 is authorized. In another example, remote server 190 may transmit security policies 198 (updated with security rules and/or whitelists associated with a new external device) to TCU 155 in response to receiving access notification 167 to update security policies 164 and facilitate a determination by TCU 155, using updated security policies, of whether access request 166 is authorized. Once TCU 155 determines, according to embodiments, whether network access request 166 is authorized or unauthorized, TCU 155 may transmit access command 168 to security module 110 via automotive controller network 170 and/or local network 175.

Access command 168 of embodiments may contain information indicating whether network access request 166 is authorized and instructions for permitting or denying access to automotive controller network 170. If access command 168 indicates that network access request 166 has been determined to be authorized, security module 110 may operationally enable first interface 126 (e.g., physically and communicatively coupled to access port 130) and relay network access request 166, buffered in database 118, onto automotive controller network 170 via access port 130. When first interface 126 is operationally enabled, security module 110 of embodiments preferably continues to monitor transmissions from external device 185 received at second interface 128 to detect any network access requests (e.g., one or more subsequent network access request 166) that are not authorized by access command 168 and operationally disable first interface 126 in response. In some embodiments, access command 168 may instruct security module 110 to permit subsequent network access requests (e.g., one or more network access request 166) received from external device 185 to interact with automotive controller network 170 without security module 110 needing to seek additional authorization from TCU 155. For example, access command 168 may contain excerpts of the whitelists and security rules of security policies 164 associated with external device 185. These excerpts may be stored in database 118 of security module 110, thereby allowing security module 110 to selectively permit or deny subsequent network access requests based on the excerpts, without needing to contact TCU 155. In another example, access command 168 may specify that external device 185 is authorized for read access to automotive controller network 170, but may also instruct security module 110 to seek authorization from TCU 155 for any subsequent network access requests involving a write access. In some embodiments, access command 168 may indicate that network access requests (e.g., one or more of network access request 166) from external device 185 are permitted to interact with automotive controller network 170 for a single request (e.g., one network access request), a single session (e.g., until external device 185 physically and communicatively decouples from security module 110), for a pre-determined time period (e.g., fifteen minutes, thirty minutes, one hour, etc.), or combinations thereof.

However, if access command 168 indicates that network access request 166 is unauthorized, security module 110 of embodiments may maintain first interface 126 in an operationally disabled state (e.g., physically coupled but communicatively decoupled with access port 130). In some embodiments, access command 168 may instruct security module 110 to operationally disable second interface 128. For example, access command 168 may indicate that network access request 166 is unauthorized for containing malicious code and instruct security module 110 to operationally disable second interface 128 to protect the internal components (e.g., processor 112, memory 114, internal network interface 120, etc.) of security module 110 from tampering or intrusion by external device 185. In additional or alternative embodiments, security module 110 may transmit a denial notification to external device 185. The denial notification may include information suitable for presentation on a display of external device 185 to inform the user of external device 185 that access to automotive controller network 170 is denied and/or to provide the user with contact information associated with one or more custodians of security policies 164 to whom authorization may be requested for subsequent access requests (e.g., one or more subsequent network access request 166). Security module 110 preferably clears any buffered network access requests that are determined to be unauthorized from database 118.

In some embodiments, security module 110 may be configured to independently determine whether network access request 166 is authorized, without needing to transmit access notification 167 to TCU 155 and/or receiving access command 168. Database 118 of security module 110 may include excerpts of security policies 164 previously received from TCU 155 (e.g., excerpts particularized to external device 185 received in a previous access command, generalized excerpts detailing benign operations and/or ECU targets, etc.) that security module 110 may apply to determine whether network access request 166 is authorized. For example, security module 110 may receive a read operation (e.g., network access request 166) directed at a temperature sensor (e.g., ECU node 140) communicatively coupled to automotive controller network 170. The excerpts of security policies 164 may indicate that a read operation to temperature sensors, oxygen sensors, and fuel level sensors are benign and therefore authorized. Accordingly, security module 110 may apply the excerpts of security policies 164 to determine that network access request 166 is authorized, operationally enable first interface 126, and relay network access request 166 to automotive controller network 170 via access port 130 without transmitting access notification 167 to TCU 155 and receiving access command 168 in response.

Although FIG. 2A describes TCU 155 transmitting access command 168 in response to receiving access notification 167 from security module 110, in some embodiments, TCU 155 may transmit access command 168 independent of a prior notification from 110. FIG. 2B depicts operations of TCU 155 and security module 110 when TCU 155 initiates secured network operation 169. Secured network operation 169 may include read and/or write operations to ECU node 140, firmware updates for ECU node 140, delivering protected data to ECU Node 140, any other operations or protected data intended for ECU Node 140, or combinations thereof. To prevent interception and/or spoofing of secured network operation 169 by external device 185, TCU 155 of embodiments may independently transmit access command 168 to security module 110 with instructions to operationally disable first interface 126 and/or second interface 128. For example, TCU 155 may transmit access command 168 in response to receiving a firmware update from remote server 190 for a throttle control ECU (e.g., ECU node 140) of vehicle 102 to disable access to automotive controller network 170 via access port 130 while TCU 155 transmits firmware updates (e.g., secured network operation 169) to ECU Node 140 via automotive controller network 170. In some embodiments, access command 168 may instruct security module 110 to operationally disable second interface 128, thereby ignoring any incoming network access requests (e.g., one or more of network access request 166), until receiving a subsequent access command from TCU 155. Additionally or alternatively, access command 168 may instruct security module 110 to operationally disable first interface 126 and/or delay transmitting access notifications (e.g., one or more of access notification 167), thereby allowing security module 110 to buffer incoming network access requests in database 118, until receiving a subsequent access command from TCU 155 to resume monitoring operations on access port 130 and/or transmit any buffered network access requests, as discussed above with respect to FIG. 2A.

While first interface 126 and/or second interface 128 of security module 110 are operationally disabled according to embodiments, TCU 155 may transmit secured network operation 169 via automotive controller network 170. In some embodiments, TCU 155 may send a subsequent access command (e.g., a subsequent access command 168) after receiving data frames acknowledging receipt of secured network operation 169. Continuing the previous example, after receiving a receipt acknowledgement from ECU node 140, TCU 155 may transmit a subsequent access command to security module 110 with instructions to resume monitoring operations on access port 130, as discussed above with respect to FIG. 2A.

According to embodiments, TCU 155 may send additional signaling instructions to security module 110 such as, for example, instructions to reboot security module 110, to reset core applications of security module 110 (e.g., return first interface 126 and second interface 128 to their operational defaults, clear database 118, etc.), to operationally disable security module 110 (e.g., modifying the operational states of first interface 126 and second interface 128), to install firmware updates for security module 110, to synchronize time between TCU 155 and security module 110, to transmit handshake transmission to security module 110 to monitor the continued presence of security module 110 on automotive controller network 170, any other instructions related to the relationship between security module 110 and TCU 155 as described herein, or combinations thereof. TCU 155 of embodiments may also send signaling instructions to remote server 190 to enhance the security of automotive controller network 170 (e.g., request updated security policies; notify remote server 190 that TCU 155 has detected the presence of malicious code on automotive controller network 170, as discussed below; notify remote server 190 that security module 110 has been physically decoupled from access port 130; etc.). In addition to one or more of the aforementioned signaling protocols, security module 110 may log incidents on first interface 126 and/or second interface 128, capture/upload information associated with the operational state of first interface 126 and/or second interface 128 (e.g., communicatively coupled or decoupled, physically coupled or decoupled, etc.), report monitored data frames passing from external device 185 to access port 130 via security module 110 (e.g., subsequent network access requests 166 not authorized by access command 168, analytics on the types and frequency of transmissions to and from external device 185, etc.), report detection of malicious code on automotive controller network 170 to TCU 155 and/or remote server 190, respond (e.g., acknowledgement, error, timeout, etc.) to any signaling instructions from TCU 155, or combinations thereof.

In some embodiments, TCU 155 may apply security policies 164 (e.g., whitelists containing references for malicious code fragments, etc.) to monitor data frame transmissions on automotive controller network 170 to detect malicious code and send signaling instructions to security module 110, ECU nodes 140, 145, and 150, and remote server 190 if any malicious code is detected. For example, TCU 155 may detect a compromised data frame containing malicious code on automotive controller network 170 that bypassed security module 110 (e.g., transmitted onto automotive controller network 170 via an external radio ECU by an external device communicatively coupled to vehicle network 177, transmitted onto automotive controller network 170 by an external device spliced directly into automotive controller network 170, etc.) and may take action to mitigate and/or prevent any damage caused by the malicious code (e.g., transmit a security alert to remote server 190; transmit a high-priority, colliding data frame, as discussed below with respect to establishing an encryption infrastructure, to block receipt of the compromised data frame; transmit regularly-backed-up images of one or more of the plurality of ECUs to overwrite changes by the malicious code; etc.). In additional or alternative embodiments, security module 110 may apply excerpts of security policies 164 (e.g., whitelists containing references for malicious code fragments, etc.) received from TCU 155 support the operations of TCU 155 described herein (e.g., detecting malicious code, mitigating and/or preventing damage by malicious code, etc.).

In some embodiments, TCU 155 and security module 110 of FIG. 1 may be configured to establish an encryption infrastructure across automotive controller network 170 so that each node (e.g., a select node of ECU nodes 140, 145, and 150) may be uniquely identified. In some embodiments, TCU 155 may assign vehicle encryption keys of security policies 164 to the nodes (e.g., a plurality of or all of ECU nodes 140, 145, and 150) of automotive controller network 170. In operation according to embodiments, the nodes of automotive controller network 170 may use their respective assigned vehicle encryption keys with a cryptographic algorithm such as AES (in any one of its multiple cryptographic modes, such as CBC, CFB, ECB, GCM, etc.), 3DES, RSA, ECC, Elliptic-curve Diffie-Hellman (ECDH), Elliptic-curve Integrated Encryption Scheme (ECIES), or other types of cryptographic encryption algorithms to encrypt and/or digitally sign the data frames they transmit onto automotive controller network 170. In some embodiments, TCU 155 may have generated the vehicle encryption keys of security policies 164 using the vehicle seed parameters of security policies 164. In additional or alternative embodiments, TCU 155 may have received the vehicle encryption keys of security policies 164 from remote server 190.

According to embodiments, the vehicle encryption keys of security policies 164 may be used in conjunction with digital certificates of security policies 164 to establish a public key infrastructure (PKI) on automotive controller network 170. TCU 155 of embodiments may be configured to function as a vehicle-local certificate authority for signing and issuing vehicle encryption keys and digital certificates to the nodes (e.g., a plurality of or all of ECU nodes 140, 145, and 150) in order to enable message (e.g., data frame) encryption on automotive controller network 170. In some embodiments, TCU 155 may assign vehicle encryption keys and digital certificates to the nodes (e.g., a plurality of or all of ECU nodes 140, 145, and 150) by individually polling the nodes to invite requests for vehicle encryption keys and digital certificates. As individual nodes (e.g., a select node of ECU nodes 140, 145, and 150) contact TCU 155 via automotive controller network 170 in response to polling by TCU 155, TCU 155 may assign vehicle encryption keys, preferably a public-private key pair, and a digital signature to each individual node to facilitate sender identification and ensure message authenticity of subsequent messages transmitted by the individual nodes via automotive controller network 170. Additionally or alternatively, TCU 155 may sequentially transmit data frames to individual nodes (e.g., a select node of ECU nodes 140, 145, and 150), assigning vehicle encryption keys and a digital signature to each individual node for use with subsequent messages transmitted by the individual nodes via automotive controller network 170. In additional or alternative embodiments, the operations for assigning vehicle encryption keys and digital signature to the nodes (e.g., a plurality of or all of ECU nodes 140, 145, and 150) on automotive controller network 170 may be executed by security module 110. In such embodiments, TCU 155 may operate as a certificate repository for assigned digital certificates and may facilitate local verification of signatures.

In operation according to embodiments, ECU node 140 may embed its assigned digital signature into data frames that it transmits via automotive controller network 170 and encrypt the same using its assigned encryption keys. In this way, the PKI enables other components coupled to automotive controller network 170 (e.g., ECU nodes 145 and 150, TCU 155, security module 110, etc.) to identify ECU Node 140 as the source of any data frames that ECU Node 140 transmits via automotive controller network 170. In additional or alternative embodiments, TCU 155 and/or security module 110 may monitor data frame transmissions on automotive controller network 170 to determine whether the embedded digital signature within the monitored data frames correspond to assigned digital signatures. For example, if TCU 155 identifies a data frame on automotive controller network 170 that lacks a digital signature or contains a digital signature that does not correspond to any assigned signature, TCU 155 may determine that the identified data frame is unauthorized. Accordingly, TCU 155 may intentionally flood automotive controller network 170 with a colliding data frame, set with the highest priority identifiers, that instructs all recipients to ignore the unauthorized data frame. Preferably, the priority data frame transmitted by TCU 155 and/or security module 110 in response to an unauthorized data frame will be received by communication controllers 143, 148, and 153 of ECU nodes 140, 145, and 150 and accordingly prioritized over the unauthorized data frame.

Referring to FIG. 3, alternative configurations of system 100 may exclude TCU 155 (e.g., TCU 155 may not be deployed in vehicle 102, TCU 155 may not be communicatively coupled to automotive controller network 170, TCU 155 has malfunctioned and may be unable to perform authorization determinations, etc.), and such a configuration is depicted as a system 300. System 300 may include vehicle 102, security module 310, access port 130, ECU nodes 140, 145, and 150, remote server 390, and network relay 355. System 300 shall be described herein with respect to differences to system 100 of FIG. 1. Security module 310 may be physically and communicatively coupled to access port 130 and, thereby, may be communicatively coupled to ECU nodes 140, 145, and 150 via automotive controller network 170 and communicatively coupled to network relay 355 via local network 175. Network relay 355 may be communicatively coupled to remote server 390 via remote network 180.

Network relay 355 of embodiments may include processor 356, memory 358, internal network interface 360, and external network interface 362. Preferably, processor 356, memory 358, internal network interface 360, and external network interface 362 are configured within a small package such as, for example, an omnidirectional antenna housing (e.g., shark fin antenna housing, dome antenna housing, disk antenna housing, etc.), or other packaging suitable for installation on vehicle 102 (e.g., exterior and/or interior roof, exterior and/or interior rear or tail section, exterior and/or interior side pillars, etc.). Internal network interface 360 may be configured to communicatively couple network relay 355 to security module 310 via local network 175. And external network interface 362 may be configured to communicatively couple network relay 355 to remote server 390 via remote network 180. Processor 356 of embodiments may be configured to perform functions as described herein (e.g., route transmissions received from local network 175 via internal network interface 360 to remote network 180 via external network interface 362 and vice versa, etc.). In operation according to embodiments, memory 358 may store instructions 359 that, when executed by processor 356, cause processor 356 to perform functions as described herein. It is noted that internal network interface 360 and external network interface 362 are depicted as singular interfaces for purposes of illustration, rather than by way of limitation, and, in other embodiments of system 300, internal network interface 360 and external network interface 362 may each include more than one wireless interface configured to communicatively couple network relay 355 with local network 175 and remote network 180, respectively. For example, internal network interface 360 may include a Wi-Fi transceiver and a wireless USB transceiver, both configured to communicatively couple with security module 310 via local network 175, and external network interface 362 may include a satellite modem (e.g., L-band, Ku-band, Ka-band, etc.) and an LTE transceiver, both configured to communicatively couple with remote server 390 via remote network 180. In some embodiments, network relay 355 may be incorporated within security module 310 and facilitate direct communication between security module 310 and remote server 390. Additionally or alternatively, network relay 355 may be TCU 155 that may be malfunctioning or may be configured without communications controller 156 and transceiver 157 lack but may still be capable of facilitating communication between security module 310 and remote server 390 and/or performing other functions described herein.

According to embodiments, preferably some or all of the functionality of TCU 155 of FIG. 1 may be distributed between security module 310 and remote server 390. Security module 310 of embodiments may include processor 312, memory 314, wireless interface 320, first interface 326, and second interface 328. Wireless interface 320 of embodiments corresponds to internal network interface 120 of FIG. 1 and may communicatively couple security module 310 with local network 175 to facilitate communication with network relay 355 via local network 175. In operation according to embodiments, first interface 326 and second interface 328 correspond to the functionality of first interface 126 and second interface 128 of FIG. 1, respectively.

In operation according to embodiments, processor 312 may be configured to perform functions as described herein (e.g., selectively deny access to automotive controller network 170 via access port 130, monitor data frame transmissions via automotive controller network 170, monitor physical coupling status with access port 130, establish an encryption infrastructure on automotive controller network 170, etc.). Preferably, any registers or other form of operational storage (e.g., cache, etc.) of processor 312 are zeroizable upon detection of certain conditions such as, for example, disconnect of security module 310 from automotive controller network 170 and/or catastrophic power outage on automotive controller network 170, thereby preventing malicious reverse-engineering of the internal state of processor 312. In operation according to embodiments, memory 314 may store instructions 316 that, when executed by processor 312, cause processor 312 to perform functions as described herein. Preferably, memory 314 is encrypted to prevent tampering and/or modification by external device 185.

Memory 314 of embodiments may include similar memory devices to memory 114 of FIG. 1 and may store database 318 containing information that may be used to support the operations of security module 310. In accordance with embodiments, exemplary information stored at database 318 and used to support the operations of security module 310 may include information associated with network access request 166 (e.g., nature and/or timing of the network access request, identity of an ECU that external device 185 seeks to interact with, identifier 186, etc.), incident logs associated with the connection status between security module 310 and access port 130, and one or more received access commands (e.g., one or more of access command 168 of FIGS. 4A and 4B). In some embodiments, database 318 may include security policies 364 (e.g., whitelists, security rules, vehicle encryption keys, vehicle seed parameters, etc.), as discussed below with respect to excerpts of security policies 398 and establishing an encryption infrastructure, and ECU data 365 (e.g., regularly-backed-up images of ECU nodes 140, 145, and 150, metadata associated with protected data installed and/or scheduled for installation to one or more of ECU nodes 140, 145, and 150, etc.), as described herein.

Remote server 390 of embodiments may include processor 392 and memory 394, and network interface 399 to facilitate communication with remote network 180. It is noted that network interface 399 is depicted as a singular interface for purposes of illustration, rather than by way of limitation, and, in other embodiments of system 300, network interface 399 may include more than one network interface configured to communicatively couple remote server 390 to remote network 180. In operation according to embodiments, processor 392 may be configured to perform functions as described herein (e.g., determine whether network access request 166 is authorized to interact with automotive controller network 170 via access port 130, transmit access command 168 to security module 310, transmit excerpts of security policies 398 to security module 310 to update security policies 364, etc.). Memory 394 of embodiments may correspond to the memory devices of memory 194 of FIG. 1. In operation according to embodiments, memory 394 may store instructions 396 that, when executed by processor 392, cause processor 392 to perform functions as described herein. The functionality of remote server 390 may be implemented on a single server. Alternatively, the functionality of remote server 390 may be implemented across multiple servers. For example, security policies 398, discussed below, may be mirrored across multiple servers (e.g., a plurality of remote server 390), but determining whether network access request 166 is authorized to interact with automotive controller network 170 may be executed by a server (e.g., a select remote server 390 of a plurality of servers) within the closest proximity to vehicle 102 to minimize delay.

In an embodiment, memory 394 may store database 397 containing information that may be used to support the operations of remote server 390. In accordance with embodiments, exemplary information stored at database 397 and used to support the operations of remote server 390 may include protected data, encryption keys, seed parameters, digital signatures, ECU data 391, and/or security policies 398. Protected data of embodiments may include data (e.g., software, firmware, other control instructions, etc.) updates for automotive ECUs, any other form of data content for which protection is provided by embodiments of the invention to prevent unauthorized use or modification, or combinations thereof, and the encryption keys (e.g., first-tier encryption keys, second tier encryption asymmetric keys, second tier encryption symmetric keys, etc.) and seed parameters (e.g., shared secret suitable for establishing a common algorithmic mode of cryptographic operation to facilitate encryption key generation) may be used to encrypt transmissions between remote server 390 and security module 310. According to embodiments, security policies 398 may correspond to security policies 164 and 198 of FIG. 1 and may include whitelists, security rules, digital certificates, vehicle encryption keys, and/or vehicle seed parameters.

ECU data 391 of embodiments may include information associated with ECU nodes 140, 145, and 150 such as, for example, regularly-backed-up images of one or more ECUs (e.g., one or more of ECU nodes 140, 145, and 150) to facilitate recovery and/or repair, as discussed below, and metadata associated with protected data (e.g., software, firmware, code instructions, etc.) installed and/or scheduled for installation (e.g., release version, release date, installation date, etc.) to the one or more ECUs to facilitate coordination with security module 310 of protected data delivery to vehicle 102. The regularly-backed-up ECU images of embodiments may be received from security module 310 via remote network 180 in response to polling (e.g., nightly, weekly, etc.) of the ECUs (e.g., one or more of ECU nodes 140, 145, and 150) by security module 310 via automotive controller network 170. The metadata of embodiments, may be recorded and/or updated, for example, as protected data intended for vehicle 102 is received from a manufacturer or designated proxy associated with vehicle 102, as protected data is transmitted to security module 310 for transfer to a corresponding ECU (e.g., a select ECU of ECU nodes 140, 145, and 150), and/or based on polling (e.g., nightly, weekly, monthly, etc.) conducted by security module 310 via automotive controller network 170 that may be transmitted to remote server 390 via local network 175, network relay 355, and remote network 180. In operation according to embodiments, remote server 390 may use ECU data 391 to independently determine whether one or more ECUs (e.g., one or more of ECU nodes 140, 145, and 150) may benefit from receiving protected data and coordinate delivery of the protected data to vehicle 102 with security module 310. For example, remote server 390 may determine that new firmware (e.g., protected data) is available for ECU node 140 and send a push notification to security module 310 regarding ECU node 140 and information associated with the new firmware (e.g., release date, release version, file size, etc.). In response, security module 310 may compare the information of the push notification with metadata of ECU data 365 associated with ECU Node 140, communicate with remote server 390 if security module 310 detects any discrepancies, coordinate initiation of secured network operation 169 (e.g., secured delivery of the firmware update) by remote server 390, as described below with respect to FIG. 4B, to communicate and install the firmware update to ECU node 140. In some embodiments, remote server 390 may transmit information of ECU data 391 associated with one or more ECUs (e.g., one or more of ECU nodes 140, 145, and 150) of vehicle 102 to security module 310 via remote network 180 to facilitate harmonization of ECU data 391 and ECU data 365 by security module 310. In additional or alternative embodiments, remote server 390 may receive information of ECU data 365 associated with one or more ECUs (e.g., one or more of ECU nodes 140, 145, and 150) of vehicle 102 from security module 310 via remote network 180 to facilitate harmonization of ECU data 391 and ECU data 365 by remote server 390. It is noted that ECU data 391 is discussed herein with respect to a single vehicle (e.g., vehicle 102) for purposes of illustration, rather than by way of limitation, and, in other embodiments, ECU data 391 may be implemented with respect to a plurality of vehicles or even an entire fleet of vehicles and include vehicle information (e.g., make, model, VIN, etc.) for each of a plurality of vehicles and corresponding back-up images and/or protected data version.

FIG. 4A depicts operations of system 300 of FIG. 3 in accordance with an example implementation. In operation according to embodiments, communication between security module 310 and remote server 390 via local network 175, network relay 355, and remote network 180 may be encrypted using encryption keys (e.g., assigned by remote server 390, independently generated using common seed parameters, etc.) of database 397 and/or digitally signed using digital certificates (e.g. assigned by remote server 390) of database 397.

First interface 326 of embodiments preferably is operationally disabled (e.g., physically coupled to and communicatively decoupled with access port 130) when security module 310 detects network access request 166 (e.g., a read and/or write instruction from external device 185 intended for ECU node 140, a physical coupling of external device 185 to second interface 328 of security module 310, etc.). In operation according to embodiments, security module 310 may store information associated with network access request 166 (e.g., operation of network access request 166, target node for network access request 166, identifier 186, etc.) in database 318, effectively buffering network access request 166. While network access request 166 is buffered according to embodiments, security module 310 may send access notification 167 to remote server 390 via local network 175, network relay 355, and remote network 180. Access notification 167 preferably includes the information associated with network access request 166 buffered in database 318.

Upon receiving access notification 167 from security module 310, remote server 390 of embodiments may apply security policies 398 to determine whether network access request 166 is authorized. For example, remote server 390 may compare identifier 186 associated with external device 185 and the information associated with network access request 166 contained in access notification 167 to one or more whitelists and security rules of security policies 398 specifying authorized identifiers and authorized operations associated with each authorized identifier. In another example, security rules of security policies 398 may specify that a particular identifier of the one or more whitelists is authorized to interact with automotive controller network 170 at specific points in time (e.g., during a scheduled service appointment for vehicle 102, etc.). If identifier 186 is not listed in one or more whitelists of security policies 398, remote server 390 may determine, according to one or more security rules of security policies 398, that network access request 166 is unauthorized. For example, if identifier 186 is listed in one or more whitelists of security policies 398 but security policies 398 also specify that identifier 186 is only authorized to perform read operations and access notification 167 indicates that network access request 166 is a write operation, remote server 390 may determine that network access request 166 is unauthorized. In yet another example, remote server 390 may determine that network access request 166 is authorized when identifier 186 is listed in and the nature and/or timing of network access request 166 (e.g., a write operation, a read operation, etc.) is also specified in security policies 398. Once remote server 390 determines, according to embodiments, whether network access request 166 is authorized, remote server 390 may transmit access command 168 to security module 310 via remote network 180, network relay 355, and local network 175.

If access command 168 indicates that network access request 166 has been determined to be authorized, security module 310 of embodiments may operationally enable first interface 326 and transmit network access request 166, buffered in database 318, onto automotive controller network 170 via access port 130. In some embodiments, access command 168 may instruct security module 310 to permit subsequent network access requests (e.g., one or more network access request 166) received from external device 185 to interact with automotive controller network 170 without security module 310 needing to seek additional authorization from remote server 390. For example, access command 168 may contain excerpts of the whitelists and security rules of security policies 398 associated with external device 185 that may be stored in database 318 as security policies 364, thereby allowing security module 310 to selectively permit or deny subsequent network access requests based on security policies 364, without needing to contact remote server 390. In another example, access command 168 may specify to security module 310 that external device 185 is authorized for read access to automotive controller network 170, but security module 310 may need to seek authorization from remote server 390 for any subsequent network access requests involving a write access. The instructions of access command 168 of embodiments may indicate that network access requests (e.g., one or more of network access request 166) from external device 185 are permitted access to automotive controller network 170 for a single request (e.g., one network access request), a single session (e.g., until external device 185 physically and communicatively decouples from security module 310), for a pre-determined time period (e.g., fifteen minutes, thirty minutes, one hour, etc.), or combinations thereof.

However, if access command 168 indicates that network access request 166 is unauthorized, security module 310 may maintain first interface 326 in an operationally disabled state (e.g., physically coupled but communicatively decoupled with access port 130). In some embodiments, security module 310 may transmit a denial notification to external device 185, as discussed above with respect to security module 110 of FIG. 1. The denial notification may include information suitable for display on external device 185 to inform any user of external device 185 that access is denied and/or to provide contact information associated with one or more custodians of security policies 164 to whom authorization may be requested in order to obtain authorization for subsequent access requests (e.g., one or more subsequent network access request 166).

In some embodiments, security module 310 may be configured to independently determine whether network access request 166 is authorized, without needing to transmit access notification 167 to remote server 390 and/or receiving access command 168. Database 318 of security module 310 may include security policies 364 previously received from remote server 390 (e.g., excerpts of security policies 398 particularized to external device 185, generalized excerpts of security policies 398 detailing benign operations and/or ECU targets, etc.) in a previous access command and/or when security module 310 was first initialized (e.g., communicatively coupled to access port 130). Security module 310 may apply security policies 364 to determine whether network access request 166 is authorized. For example, security module 310 may receive a read operation (e.g., network access request 166) directed at a temperature sensor (e.g., ECU node 140) communicatively coupled to automotive controller network 170. Security policies 364 of this example may indicate that a read operation to temperature sensors, oxygen sensors, and fuel level sensors are benign and therefore authorized. Accordingly, security module 310 may apply security policies 364 to determine that network access request 166 is authorized, operationally enable first interface 326, and relay network access request 166 to automotive controller network 170 via access port 130 without transmitting access notification 167 to remote server 390 and receiving access command 168 in response.

Although FIG. 4A describes remote server 390 transmitting access command 168 in response to receiving access notification 167 from security module 310, in some embodiments, remote server 390 may transmit access command 168 independent of a prior notification from 310. FIG. 4B depicts operations of remote server 390 and security module 310 when remote server 390 initiates secured network operation 169. To prevent interception and/or spoofing of secured network operation 169 by external device 185, remote server 390 of embodiments may independently transmit access command 168 to security module 310 with instructions to operationally disabling second interface 328 (e.g., physically coupled but communicatively decoupled with external device 185). For example, remote server 390 may transmit access command 168 prior to transmitting a firmware update (e.g., secured network operation 169) for a throttle control ECU (e.g., ECU node 140) of vehicle 102 to security module 310 for security module 310 to relay to ECU node 140 via automotive controller network 170.

While second interface 328 of security module 310 is operationally disabled according to embodiments, remote server 390 may transmit secured network operation 169 to security module 310 via local network 175, network relay 355, and remote network 180. Once secured network operation 169 has been received, security module 310 may transmit secured network operation 169 onto automotive controller network 170. In some embodiments, security module 310 may seek permission from remote server 390 to resume monitoring operations on access port 130, as discussed above with respect to FIG. 4A. Additionally or alternatively, security module 310 may resume monitoring operations on access port 130 after transmitting secured network operation 169 onto automotive controller network 170. Remote server 390 and security module 310 of embodiments may exchange additional signaling instructions and/or information as discussed above with respect to TCU 155 and security module 110.

In some embodiments, security module 310 may apply security policies 364 (e.g., whitelists containing references for malicious code fragments, etc.) to monitor data frame transmissions on automotive controller network 170 to detect malicious code and send signaling instructions to ECU nodes 140, 145, and 150 and remote server 390 if any malicious code is detected. For example, security module 310 may detect a compromised data frame containing malicious code on automotive controller network 170 that bypassed security module 310 (e.g., transmitted onto automotive controller network 170 by an external radio ECU, etc.) and may take action to mitigate and/or prevent any damage caused by the malicious code (e.g., transmit a security alert to remote server 390; transmit a high-priority, colliding data frame, as discussed below with respect to establishing an encryption infrastructure, to block receipt of the compromised data frame; transmit regularly-backed-up images, stored in database 318 and/or received from database 397 of remote server 390, of one or more of the plurality of ECUs to overwrite changes by the malicious code; etc.).

In some embodiments, security module 310 of FIG. 3 may be configured to impose an encryption infrastructure across automotive controller network 170 so that each node (e.g., a select node of ECU nodes 140, 145, and 150) may be uniquely identified. Security module 310 of embodiments may assign vehicle encryption keys, included in security policies 364 received from remote server 390, to the nodes (e.g., a plurality of or all of ECU nodes 140, 145, and 150) on automotive controller network 170. In operation according to embodiments, the nodes on automotive controller network 170 may use the assigned vehicle encryption keys with a cryptographic algorithm, as discussed with respect to FIG. 1, to encrypt and/or digitally sign data frames transmitted on automotive controller network 170. In some embodiments, security module 310 may have received the vehicle encryption keys of security policies 364 from remote server 390. In additional or alternative embodiments, security module 310 may have generated the vehicle encryption keys using the vehicle seed parameters of security policies 364 received from remote server 390.

According to embodiments, the vehicle encryption keys of security policies 364 may be used in conjunction with digital certificates of security policies 364 and/or 398 to establish a public key infrastructure (PKI) on automotive controller network 170. Security module 310 of embodiments may be configured to function as a vehicle-local certificate authority for signing and issuing vehicle encryption keys and digital certificates from security policies 364 (e.g., received from remote server 390 and corresponding to security policies 398) to the nodes (e.g., a plurality of or all of ECU nodes 140, 145, and 150) to facilitate message (e.g., data frame) encryption on automotive controller network 170. In some embodiments, security module 310 may individually poll the nodes (e.g., a plurality of or all of ECU nodes 140, 145, and 150) of automotive controller network 170 to invite requests for vehicle encryption keys and digital certificates. As individual nodes (e.g., a select node of ECU nodes 140, 145, and 150) contact security module 310 via automotive controller network 170 in response to polling by security module 310, security module 310 may assign vehicle encryption keys, preferably a public-private key pair, and a digital signature to each individual nodes to facilitate sender identification and message authenticity of subsequent messages transmitted by the individual nodes via automotive controller network 170. Additionally or alternatively, security module 310 may sequentially transmit data frames to individual nodes on automotive controller network 170 assigning vehicle encryption keys and digital signatures and instructing the individual nodes to encrypt subsequent data frames using the encryption keys and embedding the digital signatures in the subsequent data frames. Remote server 390 of embodiments may support the PKI by operating as a certificate repository for assigned digital certificates.

In operation according to embodiments, data frame transmissions sent by an ECU node (e.g., a select node of ECU nodes 140, 145, and 150) may be embedded with an assigned digital certificate and encrypted with an assigned vehicle encryption key. In this way, the PKI facilitates the identification of the sender of a particular data frame on automotive controller network 170. In additional or alternative embodiments, security module 310 may monitor data frame transmissions on automotive controller network 170 to determine whether the embedded digital signature within the monitored data frames correspond to assigned digital signatures and transmit priority messages onto automotive controller network 170 to block any unauthorized data frames, as discussed above with respect to TCU 155 and security module 110 of FIG. 1.

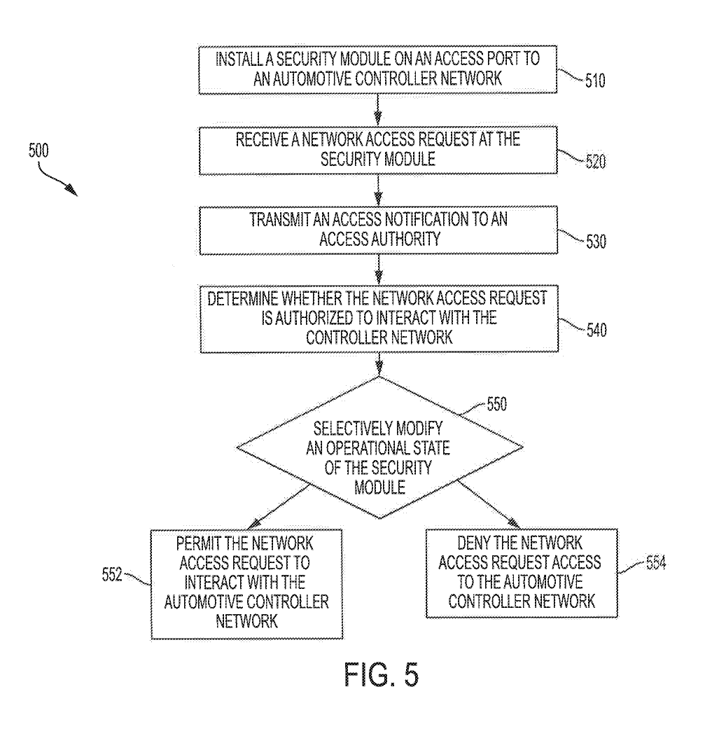

FIG. 5 illustrates process steps in a method for securing an automotive controller network from unauthorized access according to embodiments of the invention. Flow 500 may begin at block 510, which includes installing a security module on an access port to an automotive controller network. According to embodiments, the security module (e.g., security module 110 of FIGS. 1 and 2 and security module 310 of FIGS. 3 and 4), is preferably configured as a pass-through adapter with a first interface (e.g., first interface 126 of FIGS. 1 and 2 and first interface 326 of FIGS. 3 and 4) and a second interface (e.g., second interface 128 of FIGS. 1 and 2 and second interface 328 of FIGS. 3 and 4). The first interface of the security module is preferably configured to physically and communicatively couple with a standardized interface of access port (e.g., access port 130 of FIGS. 1, 2, 3, and 4). In some embodiments, the first interface may be configured with security seals (e.g., tamper-proof adhesives, locking mechanisms, etc.) suitable for preventing removal (e.g., physical decoupling) of the security module, once installed, from the access port. In additional or alterative embodiments, in the event that the first interface of the security module is physically decoupled from the access port to the automotive controller network, the security module may record the event in an incident log within memory (e.g., database 118 of memory 114 of FIG. 1 and database 318 of memory 314 of FIG. 3), transmit a decoupling notification to an access authority (e.g., TCU 155 of FIGS. 1 and 2 and/or remote server 390 of FIGS. 3 and 4), trigger an alarm (e.g., auditory, visual, etc.), other actions suitable for alerting that the access port and the automotive controller network are unsecured, or combinations thereof. The security module's second interface may correspond to the access port's standardized interface and may be configured to facilitate physical and communicative coupling with an external device (e.g., external device 185 of FIGS. 1, 2, 3, and 4). Preferably, the first and second interfaces of the security module may each be operationally enabled (e.g., physically and communicatively coupled with the access port and the external device, respectively) and operationally disabled (e.g., communicatively decoupled from the access port and the external device, respectively, without physically decoupling from either).

In operation according to embodiments, when the first and second interfaces of the security module are both operationally enabled, the external device may interact with the automotive controller network by way of the security module and the access port. However, when the first interface is operationally disabled (e.g., physically coupled but communicatively decoupled with the access port) according to embodiments, any network access requests that the security module may receive from the external device are preferably not relayed to the access port and/or the automotive controller network. When the second interface is operationally disabled (e.g., physically coupled but communicatively decoupled with the external device) according to embodiments, the external device is preferably unable to transmit signals (e.g., network access request or other data frames intended for automotive controller network) to or read signals from the security module. According to embodiments, the default state of the first interface is operationally disabled, and the default state of the second interface is operationally disabled.

Once the security module has been installed on the access port of an automotive controller network, at block 520, flow 500 may further include receiving a network access request at the security module. According to embodiments, the network access request (e.g., network access request 166 of FIGS. 1, 2, 3, and 4) may correspond to a write operation, a read operation, a physically and communicatively coupling event with respect to the second interface of the security module, other operative actions intended to interact with the automotive controller network, or combinations thereof originating from the external device and, preferably, includes an identifier associated with external device (e.g., identifier 186 of FIGS. 1, 2, 3, and 4). In some embodiments, the security module may transmit a query to the external device via the second interface to request the external device's identifier. In further embodiments, the security module may independently determine (e.g., based on excerpts of security policies 164 received from TCU 155 of FIGS. 1 and 2, based on security policies 398 received from remote server 390 of FIGS. 3 and 4, etc.) that the network access request is harmless and therefore authorized, even if the external device does not provide an identifier, and flow 500 may process to block 552 to permit access to the access port and the automotive controller network. Additionally or alternatively, if the external device does not provide an identifier, flow 500 may proceed to block 554 to deny access to the access port and the automotive controller network. However, if the external device provides its identifier to the security module, processing may proceed to block 530. The information associated with the network access request and the external device's identifier are preferably stored in a memory component (e.g., memory 114 of FIG. 1 and memory 314 of FIG. 3), effectively buffering the network access request.

At block 530, flow 500 may further include transmitting an access notification to an access authority. The access notification (e.g., access notification 167 of FIGS. 1, 2, 3, and 4) of embodiments may include the external device's identifier, a target node (e.g., a select node of ECU nodes 140, 145, and 150 of FIGS. 1 and 3) for the network access request, any other information describing the nature and/or timing of network access request, and/or combinations thereof. Transmissions to and from the access authority are preferably encrypted to prevent interception and/or packet sniffing by malevolent actors.

In some embodiments, the access authority may include a TCU (e.g., TCU 155 of FIGS. 1 and 2) communicatively coupled to the security module via the automotive controller network and a local network (e.g., local network 175 of FIGS. 1, 2, 3, and 4). The security module of embodiments may communicate (e.g., transmit the access notification, receive messages, etc.) with the TCU via the automotive controller network, the local network, or a combination thereof. In additional or alternative embodiments, the access authority may be a remote server (e.g., remote server 390 of FIGS. 3 and 4) communicatively coupled to the security module. The security module of embodiments may communicate (e.g., transmit the access notification, receive messages, etc.) with the remote server via the local network and a remote network (e.g., remote network 180 of FIGS. 1, 2, 3, and 4) by way of a network relay (e.g., network relay 355 of FIGS. 3 and 4) communicatively coupled to the local network and the remote network.

Once the access notification has been transmitted to the access authority, at block 540, flow 500 may further include determining whether the access request is authorized to interact with the automotive controller network. In operation according to embodiments, the access authority may use one or more security policies (e.g., security policies 164, 198, 364, and 398 of FIGS. 1, 2, 3, and 4), which include whitelists and security rules for determining whether a particular network access request is authorized. Whitelists of embodiments may include one or more lists of authorized external devices (e.g., one or more of external device 185 of FIGS. 1 and 3), users associated with the external devices, and/or authorized operations associated with authorized external devices and/or users, while the security rules may provide instructions for applying the whitelists.

For example, the access authority may compare the external device identifier and operational information associated with network access request contained in the access notification to one or more whitelists and security rules. The whitelists may specify authorized identifiers and authorized operations associated with each authorized identifier. And the security rules may prescribe that if the identifier is not listed in the whitelists, the network access request is unauthorized. In another example, if the identifier may be found in the whitelists but the whitelists also specify that the identifier is only authorized to perform read operations and the access notification indicates that network access request is a write operation, the security rules may prescribe that the network access request is unauthorized. In a third example, the access authority may determine that the network access request is authorized when the identifier and/or the nature of network access request are both specified in the whitelists and the security rules. In yet another example, the access authority of may determine that the network access request is authorized when the nature of network access request and the target ECU of the network access request are specified in the whitelists and the security rules as benign.

After the access authority determines whether the network access request is authorized, at block 540, flow 500 may further include receiving an access command based on the authorization determination. The access command (e.g., access command 168 of FIGS. 1, 2, 3, and 4) of embodiments preferably includes the information identifying the network access request, a determination whether the network access request is authorized or unauthorized, operational instructions for the security module, any other information suitable for enabling the security module to process the network access request, or combinations thereof. In some embodiments, the access command may be received from the remote server (e.g., remote server 390 of FIGS. 3 and 4) via the remote network and the local network by way of the network relay (e.g., network relay 355 of FIGS. 3 and 4). In additional or alternative embodiments, the access command may be received from the TCU via the automotive controller network, the local network, or a combination thereof.

Accordingly, processing at block 550 of flow 500 illustrated in FIG. 5 selectively modifies the operational state of the security module based on the access command. If the access command indicates that the network access request is authorized, processing according to the illustrated embodiment may proceed to block 552 to permit access to the access port and the automotive controller network. According to embodiments, the security module may operationally enable (e.g., physically and communicatively coupled to the access port) the first interface and transmit the network access request (e.g., network access request 166 buffered in the security module's memory) onto the automotive controller network via the access port. In some embodiments, the access command may instruct the security module to permit subsequent network access requests from the external device access to the automotive controller network without seeking authorization from the access authority.

For example, the access command may contain excerpts of the whitelists and security rules of the security policies associated with the external device that may be stored in the security module's memory (e.g., database 118 of memory 114 of FIG. 1 and database 318 of memory 314 of FIG. 3), thereby allowing the security module to selectively permit or deny subsequent network access requests based on the excerpts, without needing to contact the access authority. In another example, the access command may instruct the security module that the external device has read access to the automotive controller network, but the security module may need to seek authorization for any subsequent network access requests involving a write access. According to embodiments, the instructions of the access command may indicate that network access requests from the external device are permitted access to the automotive controller network for a single request (e.g., one network access request), a single session (e.g., until the external device physically and communicatively decouples from the security module), for a pre-determined time period (e.g., fifteen minutes, thirty minutes, one hour, etc.), or combinations thereof.

However, if the access command indicates that the network access request has been determined to be unauthorized, processing proceeds to block 554 to deny the external device access to the access port and the automotive controller network. According to embodiments, the security module may maintain the first interface in an operationally disabled state (e.g., physically coupled but communicatively decoupled with the access port of the automotive controller network). In some embodiments, the security module may transmit a denial notification to the external device. The denial notification may include information suitable for presentation on a display of the external device to inform any user of the external device that access is denied and/or to provide the user with contact information associated with one or more custodians of the access authority to whom authorization for subsequent access requests may be requested.

In additional or alternative embodiments, the security module may modify the operational state of the second interface (e.g., physically coupled but communicatively decoupled with the external device) to protect the security module's internal components (e.g., processor, memory, wireless interfaces, etc.) from tampering or intrusion by the external device. For example, by communicatively decoupling from the external device, the security module may avoid brute force attacks from the external device seeking to alter processor instructions (e.g., instructions 116 of FIG. 1 and instructions 316 of FIG. 3) and/or access commands (e.g., authorization determinations, whitelist and/or security rules excerpts, etc.) stored in the security module's memory, insert malicious instructions to modify the operational state of the first interface, other forms of attacks that may compromise the security module in its function as a gatekeeper to the access port, or combinations thereof.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for securing an automotive controller network in a vehicle comprising:
receiving, by a security module, a network access request from an external device, wherein the security module comprises a first interface and a second interface, wherein the first interface of the security module is physically coupled and communicatively decoupled to an access port communicatively coupled to the automotive controller network, wherein the second interface of the security module is physically and communicatively coupled to the external device, wherein the access port is communicatively coupled to a plurality of electronic control units (ECUs) via the automotive controller network, and wherein the network access request comprises at least one of a write operation from the external device to the automotive controller network, a read operation from the external device to the automotive controller network, and physically coupling the external device to the security module;
buffering, by the security module, the network access request, wherein said buffering comprises storing information associated with the network access request in memory associated with the security module;
transmitting, by the security module, the information associated with the network access request to an access authority via at least one of the automotive controller network and one or more communication networks, wherein the transmitted information is encrypted;
receiving, at the security module, an access command from the access authority via at least one of the automotive controller network the one or more communication networks, wherein the access command comprises a determination, based on one or more security policies and the transmitted information, whether the network access request is authorized, wherein the received access command is encrypted;
based on the access command indicating that the network access request is unauthorized, maintaining communicative decoupling of the security module and the access port at the first interface; and
based on the access command indicating that the network access request is authorized, communicatively recoupling the security module and the access port at the first interface and relaying the network access request to the automotive controller network via the access port.

2. The method of claim 1, wherein the one or more security policies comprise one or more whitelists, wherein the one or more whitelists comprise one or more authorized identifiers and one or more authorized events associated with each of the one or more authorized identifiers,
wherein the network access request is determined as authorized when the external device corresponds to an identifier of the one or more authorized identifiers and the network access request corresponds to an authorized event of the one or more authorized events associated with the identifier corresponding to the external device, and
wherein the network access request is determined as unauthorized when the external device does not correspond to any of the one or more authorized identifiers and the network access request does not correspond to the authorized event of the one or more authorized events.

3. The method of claim 1, further comprising:
based on the access command indicating that the network access request is unauthorized, communicatively decoupling the second interface of the security module from the external device.

4. The method of claim 1, wherein the access authority comprises a telematics control unit communicatively coupled to the security module via at least one of the automotive controller network the one or more communication networks, wherein the telematics control unit is configured to determine whether the network access request is authorized based on the one or more security policies, and wherein the access command is transmitted to the security module by the telematics control unit.

5. The method of claim 1, wherein the access authority comprises a remote server communicatively coupled to the security module via a network relay, wherein the network relay is communicatively coupled to remote server via a remote network and communicatively coupled to the security module via the one or more communication networks, wherein the remote server is configured to determine whether the network access request is authorized based on the one or more security policies, and wherein the access command is transmitted to the security module by remote server.

6. The method of claim 1, wherein the one or more security policies comprise a plurality of digital certificates and a plurality of vehicle encryption keys, wherein each of the digital certificates are configured to be embedded in transmissions via the automotive controller network, and wherein each of the vehicle encryption keys are configured to encrypt transmissions on the automotive controller network.

7. The method of claim 6, further comprising:
assigning, by the security module using the one or more security policies, a vehicle encryption key of the plurality of vehicle encryption keys to each of the plurality of ECUs;
assigning, by the security module using the one or more security policies, a digital certificate of the plurality of digital certificates to each of the plurality of ECUs;
maintaining, by the security module, a registry of assigned digital certificates; and
transmitting, by the security module, each assigned vehicle encryption key and each assigned digital certificate to a corresponding assignee ECU of the plurality of ECUs via the automotive controller network.

8. The method of claim 7, further comprising:
monitoring, by the security module, a plurality of transmissions on the automotive controller network to identify a sender associated with a monitored transmission of the plurality of transmissions, wherein the sender associated with the monitored transmission is identified using the registry of assigned digital certificates;
determining, by the security module based on the registry, whether the monitored transmission on the automotive controller network is authorized, wherein the monitored transmission is authorized when an embedded digital certificate of the monitored transmission corresponds to one of the assigned digital certificates of the registry; and
based on a determination that the monitored transmission is unauthorized, transmitting, by the security module, a high-priority transmission on the automotive controller network to block receipt of the unauthorized transmission by the plurality of ECUs.

9. A system for securing an automotive controller network in a vehicle comprising:
a security module comprising:
at least one processor configured to perform operations comprising:
receive a network access request from an external device, wherein the security module is physically coupled to an access port communicatively coupled to the automotive controller network, wherein the access port is communicatively coupled to a plurality of electronic control units (ECUs) via the automotive controller network, and wherein the network access request comprises at least one of a write operation from the external device to the automotive controller network, a read operation from the external device to the automotive controller network, and physically coupling the external device to the security module;
a memory communicatively coupled to the at least one processor, wherein the memory is configured to store information associated with the network access request;
a first interface communicatively coupled to the at least one processor, wherein the first interface is configured to facilitate physical coupling with the access port, wherein the first interface is further configured with a first and a second operational state, wherein the first operational state of the first interface communicatively decouples the first interface from the access port, and wherein the second operational state of the first interface communicatively couples the first interface with the access port; and
a second interface communicatively coupled to the at least one processor, wherein the second interface is configured to facilitate physical coupling with the external device, wherein the second interface is further configured with a first and a second operational state, wherein the first operational state of the second interface communicatively couples the second interface with the external device, and wherein the second operational state of the second interface communicatively decouples the second interface from the external device.

10. The system of claim 9, wherein the first operational state of the first interface is configured as a default state for the first interface, and wherein the first operational state of the second interface is configured as a default state for the second interface.

11. The system of claim 9, wherein the at least one processor is further configured to perform operations comprising:
buffer the network access request, wherein said buffering comprises storing information associated with the network access request in the memory communicatively coupled to the at least one processor;
transmit the information associated with the network access request to an access authority via at least one of the automotive controller network and one or more communication networks, wherein the transmitted information is encrypted;
receive an access command, wherein the access command comprises a determination, based on one or more security policies and the transmitted information, whether the network access request is authorized, wherein the received access command is encrypted;
based on the access command indicating that the network access request is unauthorized, maintain the first operational state of the first interface; and
based on the access command indicating that the network access request is authorized, trigger the second operational state of the first interface and relay the network access request to the automotive controller via the access port.

12. The system of claim 11, wherein the one or more security policies comprise one or more whitelists, wherein the one or more whitelists comprise one or more authorized identifiers and one or more authorized events associated with each of the one or more authorized identifiers,
wherein the network access request is determined as authorized when the external device corresponds to an identifier of the one or more authorized identifiers and the network access request corresponds to an authorized event of the one or more authorized events associated with the identifier corresponding to the external device, and
wherein the network access request is determined as unauthorized when the external device does not correspond to any of the one or more authorized identifiers and the network access request does not correspond to the authorized event of the one or more authorized events.

13. The system of claim 11, wherein the at least one processor is further configured to perform operations comprising:
based on the access command indicating that the network access request is unauthorized, trigger the second operational state of the second interface.

14. The system of claim 11 wherein the access authority comprises a telematics control unit communicatively coupled to the security module via at least one of the automotive controller network the one or more communication networks, wherein the telematics control unit is configured to determine whether the network access request is authorized based on the one or more security policies, and wherein the access command is transmitted to the security module by the telematics control unit.

15. The system of claim 11, wherein the access authority comprises a remote server communicatively coupled to the security module via a network relay, wherein the network relay is communicatively coupled to remote server via a remote network and communicatively coupled to the security module via the one or more communication networks, wherein the remote server is configured to determine whether the network access request is authorized based on the one or more security policies, and wherein the access command is transmitted to the security module by remote server.

16. The system of claim 11, wherein the one or more security policies comprise a plurality of digital certificates and a plurality of vehicle encryption keys, wherein each of the digital certificates are configured to be embedded in transmissions via the automotive controller network, and wherein each of the vehicle encryption keys are configured to encrypt transmissions on the automotive controller network.

17. The system of claim 16, wherein the at least one processor is further configured to perform operations comprising:
assign, using the one or more security policies, a vehicle encryption key of the plurality of vehicle encryption keys to each of the plurality of ECUs;
assign, using the one or more security policies, a digital certificate of the plurality of digital certificates to each of the plurality of ECUs;
maintain a registry of assigned digital certificates; and
transmit each assigned vehicle encryption key and each assigned digital certificate to a corresponding assignee ECU of the plurality of ECUs via the automotive controller network.

18. The system of claim 17, wherein the at least one processor is further configured to perform operations comprising:
monitor a plurality of transmissions on the automotive controller network to identify a sender associated with a monitored transmission of the plurality of transmissions, wherein the sender associated with the monitored transmission is identified using the registry of assigned digital certificates;
determine, based on the registry, whether the monitored transmission on the automotive controller network is authorized, wherein the monitored transmission is authorized when an embedded digital certificate of the monitored transmission corresponds to one of the assigned digital certificates of the registry; and
based on a determination that the monitored transmission is unauthorized, transmit a high-priority transmission on the automotive controller network to block receipt of the unauthorized transmission by the plurality of ECUs.

19. A method for securing an automotive controller network in a vehicle comprising:
transmitting, by an access authority, a first access command to a security module, wherein the security module is configured as a pass-through adapter with a first interface and a second interface, wherein the first interface of the security module is physically coupled and communicatively decoupled to an access port communicatively coupled to the automotive controller network, wherein the second interface of the security module is physically and communicatively coupled to an external device, wherein the access port is communicatively coupled to a plurality of electronic control units (ECUs) via the automotive controller network, wherein the first access command is transmitted via at least one of the automotive controller network and one or more communication networks, wherein the first access command is encrypted and causes the second interface of the security module to communicatively decouple from the external device and the first interface of the security module to communicatively couple to the access port;
transmitting, by the access authority, a secured network operation to the automotive controller network, wherein the secured network operation comprises at least one of a write operation configured to one or more ECUs of the plurality of ECUs, a read operation the one or more ECUs of the plurality of ECUs, and protected data delivery to the one or more ECUs of the plurality of ECUs; and
transmitting, by the access authority, a second access command to the security module via at least one of the automotive controller network and the one or more communication networks, wherein the second access command is encrypted and causes the second interface of the security module to communicatively couple with the external device and the first interface of the security module to communicatively decouple from the access port.

20. The method of claim 19, further comprising:
receiving, at the access authority, an access notification from the security module, wherein the access notification comprises information associated with a network access request originating from the external device and an identifier associated with the external device;
determine, by the access authority based on one or more security policies and the access notification, whether the network access request is authorized by:
comparing the identifier associated with the external device with one or more authorized identifiers of the one or more security policies, wherein the network access request is determined as unauthorized when the identifier associated with the external device does not correspond to any of the one or more authorized identifiers;
comparing the information associated with the network access to one or more authorized events associated with each of the one or more authorized identifiers, wherein the network access request is determined as unauthorized when the information associated with the network access request does not correspond to an authorized event of the one or more authorized events associated with the identifier of the external device, and wherein the network access request is determined as authorized when the identifier associated with the external device corresponds an authorized identifier of the one or more authorized identifiers and correspond to the authorized event of the one or more authorized events associated with the identifier of the external device; and
transmitting, by the access authority, a third access command to the security module via at least one of the automotive controller network and the one or more communication networks, wherein the third access command comprises the determination of whether the network access request is authorized, wherein an authorized determination causes the security module to communicatively decouple the first interface of the security module from the access port and relay the network access request to the automotive controller network via the access port, and wherein an unauthorized determination causes the security module maintain communicative decoupling of the security module and the access port at the first interface.

21. The method of claim 19, wherein the access authority comprises a telematics control unit communicatively coupled to the security module via at least one of the automotive controller network and the one or more communication networks.

22. The method of claim 19, wherein the access authority comprises a remote server communicatively coupled to the security module via a network relay, wherein the network relay is communicatively coupled to remote server via a remote network of the one or more networks and communicatively coupled to the security module via a local network of the one or more networks.
